(19) United States
(12) Patent Application Publication
(10) Pub. No.: US 2024/0348754 A1
(43) Pub. Date: Oct. 17, 2024

(54) PROJECTION DEVICE, PROJECTION CONTROL METHOD, AND RECORDING MEDIUM

(71) Applicant: NEC Platforms, Ltd., Kawasaki-shi, Kanagawa (JP)

(72) Inventor: FUJIO OKUMURA, Kanagawa (JP)

(73) Assignee: NEC Platforms, Ltd., Kawasaki-shi, Kanagawa (JP)

(21) Appl. No.: 18/683,395

(22) PCT Filed: Feb. 28, 2022
(86) PCT No.: PCT/JP2022/008233

§ 371 Date: Feb. 13, 2024

(30) Foreign Application Priority Data
Aug. 27, 2021 (JP) 2021-138619

(51) Int. Cl. H04N 9/31; G02B 5/10; G03B 21/00

(52) U.S. Cl. CPC H04N 9/3155; G02B 5/10; G03B 21/006; H04N 9/3102

(57) ABSTRACT

A projection device that includes a light source, a spatial light modulator, a partition wall, a control unit, and a curved mirror. The spatial light modulator has a modulation part in which a plurality of modulation regions to be irradiated with light emitted from the light source are set. The partition wall is disposed at a boundary between the plurality of modulation regions and separates modulated light modulated in each of the plurality of modulation regions. The control unit sets a pattern for forming the desired image in each of the plurality of modulation regions set, and controls the light source such that the modulation part is irradiated with the light. The curved mirror has a curved reflection surface to be irradiated with the modulated light, reflects the modulated light by the reflection surface, and projects projection light the projection angle of which is widened.

### TECHNICAL FIELD

The present disclosure relates to a projection device or the like that projects spatial light.

### BACKGROUND ART

A laser beam is used for spatial optical communication in which optical signals (hereinafter, also referred to as a spatial light signal) propagating in a space are transmitted and received, projection for displaying an image on a projection target surface, inspection of a surface state by projection light, and the like. From the viewpoint of safety, the output of the laser is limited by law. In a case where the output of the laser is larger than the standard specified by the law, it is necessary to intentionally drop the output of the laser using a filter or the like. For example, in a case where luminance of a projection device manufactured according to a standard specified by the law is insufficient, a desired luminance can be obtained by superimposing projection light projected from two projection devices. However, there may be a case where the number of projection devices to be installed cannot be increased due to a spatial restriction of a place where the device is arranged or a restriction in terms of cost.

PTL 1 discloses an image projection device including an optical modulator. The device of PTL 1 includes a light source, an optical modulator, a Fourier transform lens, a screen, and a projection optical system. The optical modulator modulates the laser beam incident from the light source based on the hologram data and emits the modulated laser beam. The Fourier transform lens performs Fourier transform on the light emitted from the optical modulator. The screen is arranged at an image forming position of an image by the first-order diffracted light by the optical modulator. The projection optical system generates a projection image based on the image formed on the screen.

### CITATION LIST

### Patent Literature

PTL 1: JP 2016-176996 A

### SUMMARY OF INVENTION

### Technical Problem

The device of PTL 1 performs a Fourier transform on the laser beam emitted from the light source and passing through the optical modulator with a Fourier transform lens. Then, in the device of PTL 1, the laser beam subjected to the Fourier transform is diffused by the screen and projected by the projection optical system. The device of PTL 1 projects light linearly traveling from a light source to a projection optical system onto a window shield by the projection optical system. Therefore, in the device of PTL 1, it is necessary to linearly form the optical path from the light source to the projection optical system, and it is difficult to downsize the device. The device of PTL 1 reduces the size of the window shield to prevent higher-order light of a desired image from being displayed. Therefore, in the device of PTL 1, in a case where projection light is projected to a wider range than the window shield, higher-order light of a desired image is displayed.

An object of the present disclosure is to provide a projection device or the like capable of projecting projection light not including higher-order light of a desired image over a wide range while having a compact configuration.

### Solution to Problem

A projection device according to an aspect of the present disclosure includes a light source, a spatial light modulator that has a modulation part in which a plurality of modulation regions to be irradiated with light emitted from the light source are set, and modulates the phase of the irradiated light in each of the plurality of modulation regions set in the modulation part, a partition wall that is disposed at a boundary between the plurality of modulation regions and separates modulated light modulated in each of the plurality of modulation regions, a control unit that sets a pattern for forming the desired image in each of the plurality of modulation regions set in the modulation part of the spatial light modulator, and controls the light source such that the modulation part in which the pattern is set is irradiated with the light, and a curved mirror that has a curved reflection surface to be irradiated with the modulated light modulated in each of the plurality of modulation regions set in the modulation part of the spatial light modulator, reflects the modulated light by the reflection surface, and projects projection light the projection angle of which is widened according to the curvature of the reflection surface.

A projection control method according to an aspect of the present disclosure controls a projection device including a light source, a spatial light modulator that has a modulation part in which a plurality of modulation regions to be irradiated with light emitted from the light source are set, and modulates a phase of the irradiated light in each of the plurality of modulation regions set in the modulation part, a partition wall that is disposed at a boundary between the plurality of modulation regions and separates modulated light modulated in each of the plurality of modulation regions, and a curved mirror that has a curved reflection surface to be irradiated with the modulated light modulated in each of the plurality of modulation regions set in the modulation part of the spatial light modulator, reflects the modulated light by the reflection surface, and projects projection light of which a projection angle is widened according to a curvature of the reflection surface. The projection control method includes setting a plurality of the modulation regions in the modulation part of the spatial light modulator, setting a pattern for forming a desired image in each of the plurality of modulation regions set in the modulation part of the spatial light modulator, and controlling the light source so that the light is emitted to the modulation part in which the pattern is set.

A program according to an aspect of the present disclosure controls a projection device including a light source, a spatial light modulator that has a modulation part in which a plurality of modulation regions to be irradiated with light emitted from the light source are set, and modulates a phase of the irradiated light in each of the plurality of modulation regions set in the modulation part, a partition wall that is disposed at a boundary between the plurality of modulation regions and separates modulated light modulated in each of the plurality of modulation regions, and a curved mirror that has a curved reflection surface to be irradiated with the modulated light modulated in each of the plurality of modulation regions set in the modulation part of the spatial light modulator, reflects the modulated light by the reflection surface, and projects projection light of which a projection angle is widened according to a curvature of the reflection surface. The program causes a computer to execute setting a plurality of the modulation regions in the modulation part of the spatial light modulator, setting a pattern for forming a desired image in each of the plurality of modulation regions set in the modulation part of the spatial light modulator, and controlling the light source so that the light is emitted to the modulation part in which the pattern is set.

### Advantageous Effects of Invention

According to the present disclosure, it is possible to provide a projection device or the like capable of projecting projection light not including higher-order light of a desired image in a wide range with a compact configuration.

### BRIEF DESCRIPTION OF DRAWINGS

FIG. 1 is a conceptual diagram illustrating an example of a configuration of a projection device according to a first example embodiment.

FIG. 2 is a conceptual diagram illustrating an example of an internal configuration of the projection device of the first example embodiment viewed from an upper viewing seat.

FIG. 3 is a conceptual diagram for explaining an example of a positional relationship between a modulation region set in a modulation part of a spatial light modulator of the projection device of the first example embodiment and a partition wall disposed in the modulation part.

FIG. 4 is a conceptual diagram for explaining an example of a pattern set in a modulation part of a spatial light modulator of the projection device of the first example embodiment.

FIG. 5 is a conceptual diagram for explaining a condensing point set inside the projection device of the first example embodiment.

FIG. 6A is a conceptual diagram for explaining a pattern of projection light by the projection device of the first example embodiment.

FIG. 6B is a conceptual diagram for explaining a pattern of projection light by the projection device of the first example embodiment.

FIG. 6C is a conceptual diagram for explaining a pattern of projection light by the projection device of the first example embodiment.

FIG. 7 is a conceptual diagram illustrating an example of a light source of the projection device of the first example embodiment.

FIG. 8 is a conceptual diagram illustrating an example of a light source of the projection device of the first example embodiment.

FIG. 9 is a conceptual diagram illustrating an example of a light source of the projection device of the first example embodiment.

FIG. 10 is a conceptual diagram illustrating an example of a light source of the projection device of the first example embodiment.

FIG. 11 is a conceptual diagram illustrating an example of a light source of the projection device of the first example embodiment.

FIG. 12 is a conceptual diagram illustrating an example of a configuration of a projection device of a second example embodiment.

FIG. 13 is a conceptual diagram illustrating an example of an internal configuration of the projection device of the second example embodiment viewed from an upper viewing seat.

FIG. 14 is a conceptual diagram illustrating an example of a light source of the projection device of the second example embodiment.

FIG. 15 is a conceptual diagram for explaining an example of a positional relationship between a modulation region set in a modulation part of a spatial light modulator of the projection device of the second example embodiment and a partition wall arranged in the modulation part.

FIG. 16A is a conceptual diagram for explaining a pattern of projection light by the projection device of the second example embodiment.

FIG. 16B is a conceptual diagram for explaining a pattern of projection light by the projection device of the second example embodiment.

FIG. 16C is a conceptual diagram for explaining a pattern of projection light by the projection device of the second example embodiment.

FIG. 17 is a conceptual diagram illustrating an example of a configuration of a projection device of a third example embodiment.

FIG. 18 is a conceptual diagram illustrating an example of an internal configuration of the projection device of the third example embodiment viewed from an upper viewing seat.

FIG. 19 is a conceptual diagram illustrating an example of an internal configuration of the projection device of the third example embodiment as viewed from a lower perspective.

FIG. 20 is a conceptual diagram for explaining an example of a positional relationship between a modulation region set in a modulation part of a spatial light modulator of the projection device of the third example embodiment and a partition wall arranged in the modulation part.

FIG. 21A is a conceptual diagram for explaining a pattern of projection light by the projection device of the third example embodiment.

FIG. 21B is a conceptual diagram for explaining a pattern of projection light by the projection device of the third example embodiment.

FIG. 21C is a conceptual diagram for explaining a pattern of projection light by the projection device of the third example embodiment.

FIG. 22 is a conceptual diagram illustrating an example of a configuration of a projection device of a fourth example embodiment.

FIG. 23 is a block diagram illustrating an example of a hardware configuration that enables control and processing of each example embodiment.

### EXAMPLE EMBODIMENT

Hereinafter, example embodiments of the present invention will be described with reference to the drawings. However, the example embodiments described below may be technically limited for carrying out the present invention, but the scope of the invention is not limited to the following. In all the drawings used in the following description of the example embodiment, the same reference numerals are given to the same parts unless there is a particular reason. In the following example embodiments, repeated description of similar configurations and operations may be omitted. The directions of the arrows in the drawings illustrate an example, and do not limit the directions of signals between blocks.

In all the drawings used for description of the following example embodiments, the directions of the arrows in the drawings are merely examples, and do not limit the directions of light and signals. A line indicating a trajectory of light in the drawings is conceptual, and does not accurately indicate an actual traveling direction or state of light. For example, in the drawings, a change in a traveling direction or a state of light due to refraction, diffraction, reflection, diffusion, or the like at an interface between air and a substance may be omitted, or a light flux may be expressed by one line.

### First Example Embodiment

First, a projection device according to a first example embodiment will be described with reference to the drawings. The projection device of the present example embodiment is used for spatial optical communication in which optical signals (Hereinafter, also referred to as a spatial light signal) propagating in a space are transmitted and received, projection for displaying an image on a projection target surface, inspection of a surface state by projection light, and the like. The projection device of the present embodiment may be used for applications other than optical space communication, projection, and inspection as long as the projection device is used for projecting light propagating in a space.

### (Configuration)

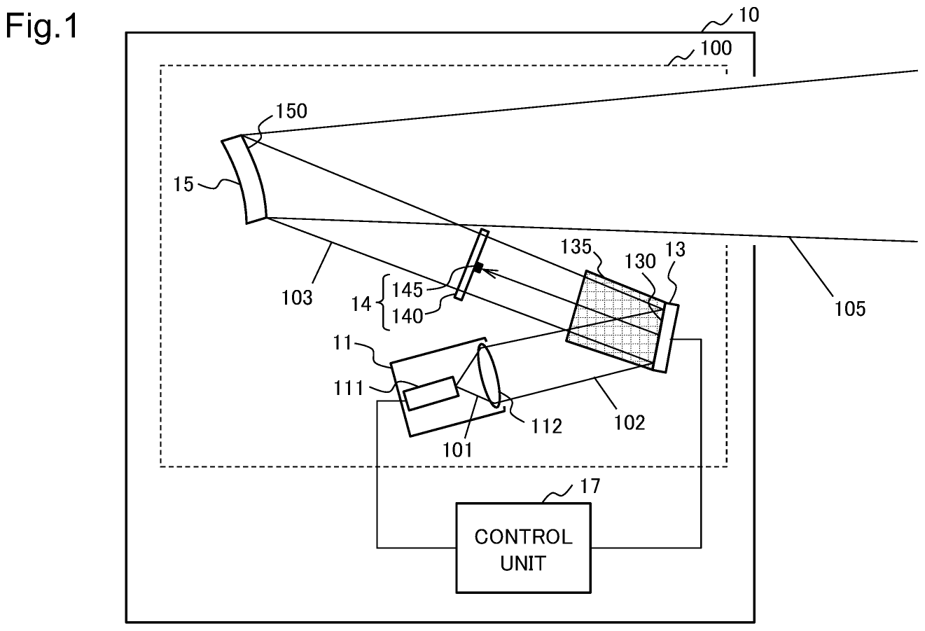

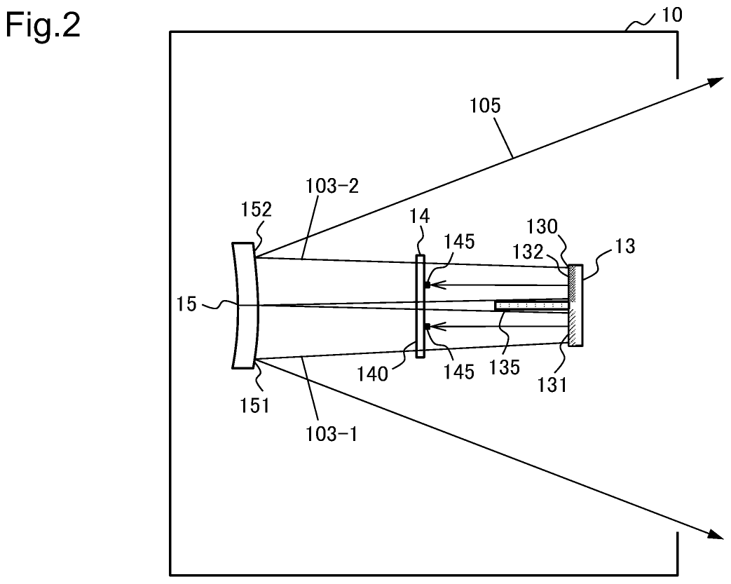

FIGS. 1 and 2 are conceptual diagrams illustrating an example of a configuration of a projection device 10 according to the present example embodiment. The projection device 10 includes a light source 11, a spatial light modulator 13, a 0th-order light remover 14, a curved mirror 15, and a control unit 17. The light source 11, the spatial light modulator 13, the 0th-order light remover 14, and the curved mirror 15 constitute a projection unit 100. FIG. 1 is a side view illustrating an internal configuration of the projection device 10 as viewed from the lateral direction. FIG. 2 is a side view illustrating the internal configuration of the projection device 10 as viewed from above. In FIG. 2, the light source 11 is omitted. FIGS. 1 and 2 are conceptual, and do not accurately represent a positional relationship between components, a traveling direction of light, and the like.

The light source 11 includes an emitter 111 and a lens 112. The light source 11 emits a laser beam 101 in two directions. The laser beam 101 emitted from the light source 11 in two directions is enlarged by the lens 112 and applied to each of two modulation regions (first modulation region 131, second modulation region 132) set in a modulation part 130 of the spatial light modulator 13. As the light source 11, a configuration including one emitter 111 and one lens 112 or a configuration including two emitters 111 and two lenses 112 can be selected. A configuration example of the light source 11 will be described later.

The emitter 111 emits the laser beam 101 of a predetermined wavelength band toward the lens 112 under the control of the control unit 17. The wavelength of the laser beam 101 emitted from the light source 11 is not particularly limited, and may be selected according to the application. For example, the emitter 111 emits the laser beam 101 in visible or infrared wavelength bands. For example, in the case of near-infrared rays of 800 to 900 nanometers (nm), the laser class can be given, and thus the sensitivity can be improved by about 1 digit as compared with other wavelength bands. For example, a high-power laser beam source can be used for infrared rays in a wavelength band of 1.55 micrometers (μm). As an infrared laser beam source in a wavelength band of 1.55 μm, an aluminum gallium arsenide phosphorus (AlGaAsP)-based laser beam source, an indium gallium arsenide (InGaAs)-based laser beam source, or the like can be used.

The lens 112 enlarges the laser beam 101 emitted from the emitter 111 in accordance with the size of the modulation part 130 of the spatial light modulator 13. The laser beam 101 emitted from the emitter 111 is enlarged by the lens 112 and emitted from the light source 11. The light 102 emitted from the light source 11 travels toward each of the two modulation regions set in the modulation part 130 of the spatial light modulator 13.

The spatial light modulator 13 includes a modulation part 130 irradiated with the light 102. In the modulation part 130, the first modulation region 131 and the second modulation region 132 are set. A partition wall 135 is disposed between the first modulation region 131 and the second modulation region 132. The partition wall 135 stands perpendicular to the surface of the modulation part 130. The partition wall 135 divides the modulation part 130 into two so that modulated light 103-1 modulated in the first modulation region 131 and the modulated light 103-2 modulated in the second modulation region 132 are not mixed immediately after being modulated by the modulation part 130. In each of the first modulation region 131 and the second modulation region 132, a pattern corresponding to an image displayed by the projection light 105 is set under the control of the control unit 17. When the spatial light modulator 13 is used, a high-order image is generated similarly to a diffraction grating because the diffraction phenomenon is used. A high-order image is not clear due to low power, but is visually recognized. The partition wall 135 removes a high-order image that can be displayed on the projection target surface.

The modulation part 130 of the spatial light modulator 13 is irradiated with the light 102 emitted from the light source 11. The light 102 incident on the modulation part 130 of the spatial light modulator 13 is modulated according to the pattern set in the modulation part 130 of the spatial light modulator 13. The modulated light 103 modulated by the modulation part 130 of the spatial light modulator 13 travels toward a reflection surface 150 of the curved mirror 15.

For example, the spatial light modulator 13 is achieved by a spatial light modulator using ferroelectric liquid crystal, homogeneous liquid crystal, vertical alignment liquid crystal, or the like. For example, the spatial light modulator 13 can be achieved by liquid crystal on silicon (LCOS). The spatial light modulator 13 may be achieved by a micro electro mechanical system (MEMS). In the spatial light modulator 13 of the phase modulation type, the energy can be concentrated on the portion of the image by operating to sequentially switch the portion on which the projection light 105 is projected. Therefore, in the case of using the spatial light modulator 13 of the phase modulation type, if the output of the light source 11 is the same, the image can be displayed brighter than other methods.

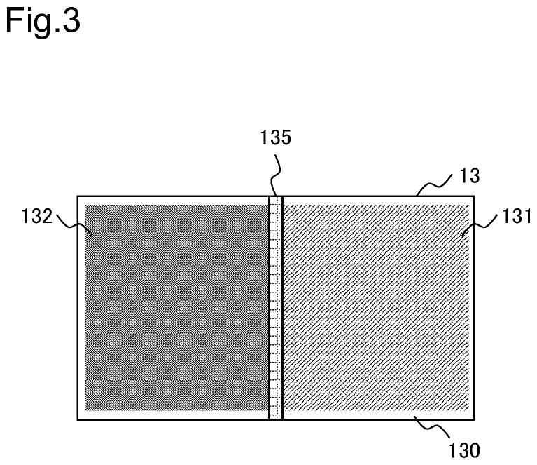

FIG. 3 is an example of the first modulation region 131 and the second modulation region 132 set in the modulation part 130 of the spatial light modulator 13. A pattern (phase image) related to an image formed by the modulated light 103-1 is set in the first modulation region 131. A phase image related to an image formed by the modulated light 103-2 is set in the second modulation region 132. For example, in a case where only one of the modulated light 103-1 and the modulated light 103-2 is used for image display, the phase image may be set only in the modulation region where the modulated light 103 used for image display is emitted.

Each of the first modulation region 131 and the second modulation region 132 allocated to the modulation part 130 of the spatial light modulator 13 is divided into a plurality of regions (also referred to as tiling). For example, each of the first modulation region 131 and the second modulation region 132 is divided into rectangular regions (also referred to as tiles) having a desired aspect ratio. Each of the plurality of tiles includes a plurality of pixels. A phase image is tiled to each of the plurality of tiles set in the first modulation region 131 and the second modulation region 132. For example, a phase image generated in advance is set in each of the plurality of tiles. A phase image relevant to a projected image is set to each of the plurality of tiles. When the modulation part 130 is irradiated with the light 102 in a state where the phase image is set in the plurality of tiles, the modulated light 103 is emitted to form an image relevant to the phase image of each tile. As the number of tiles set in the modulation part 130 increases, a clear image can be displayed. However, when the number of pixels of each tile decreases, the resolution decreases. Therefore, the size and number of tiles set in the modulation part 130 are set according to the application.

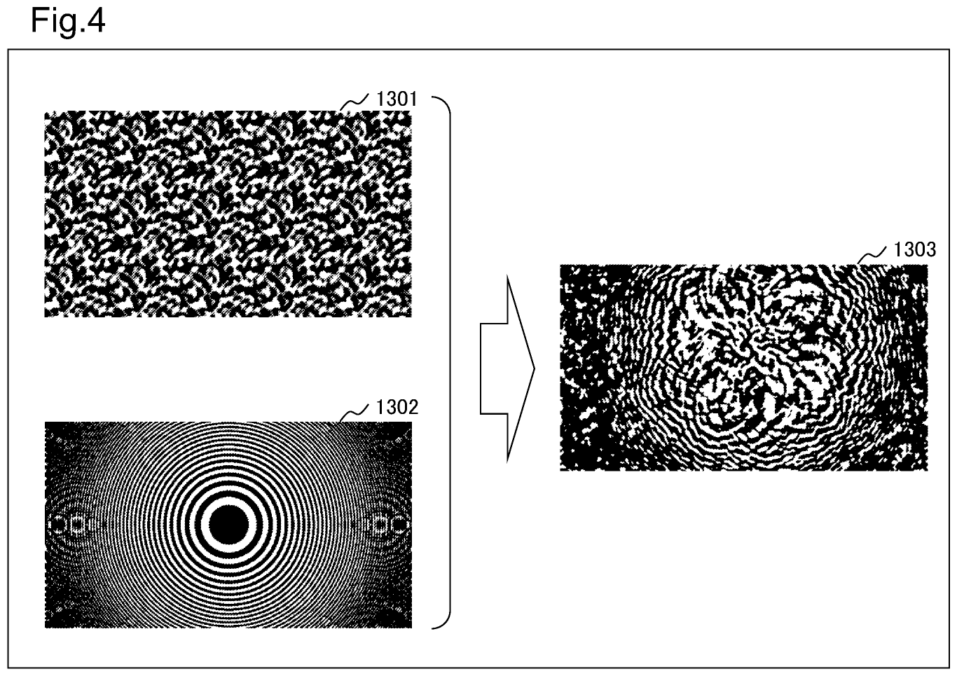

FIG. 4 is a conceptual diagram illustrating an example of patterns set in the first modulation region 131 and the second modulation region 132 of the modulation part 130 of the spatial light modulator 13. A composite image 1303 is set in each of the first modulation region 131 and the second modulation region 132. The composite image 1303 is a pattern obtained by combining a phase image 1301 for forming a desired image and a virtual lens image 1302 for condensing light for forming a desired image. The wavefront of light can be controlled by phase control, similar to diffraction. When the phase changes to a spherical shape, a spherical difference is generated in the wavefront, and a lens effect is generated. The virtual lens image 1302 changes the phase of the light 102 emitted to the modulation part 130 of the spatial light modulator 13 into a spherical shape, and generates a lens effect of condensing the light at a position (also referred to as a second condensing point) of a predetermined focal length. The image condensed by the virtual lens image 1302 is formed on the reflection surface 150 of the curved mirror 15. The second condensing point of the modulated light 103-1 modulated in the first modulation region 131 is set in a first reflection region 151 of the curved mirror 15. The modulated light 103-1 modulated in the first modulation region 131 forms an image formed by the modulated light 103-1 in the first reflection region 151 of the curved mirror 15. The second condensing point of the modulated light 103-2 modulated in the second modulation region 132 is set in a second reflection region 152 of the curved mirror 15. The modulated light 103-2 modulated in the second modulation region 132 forms an image formed by the modulated light 103-2 in the second reflection region 152 of the curved mirror 15. For example, the composite image 1303 may be generated in advance and stored in a storage unit (not illustrated). FIG. 4 is an example, and does not limit the patterns of the phase image 1301, the virtual lens image 1302, and the composite image 1303.

The modulated light 103-1 modulated in the first modulation region 131 and the modulated light 103-2 modulated in the second modulation region 132 are separated by the partition wall 135 immediately after being emitted from the modulation part 130. The modulated light 103-1 and the modulated light 103-2 can be set so as to be mixed with each other after being reflected by the reflection surface 150 of the curved mirror 15, or can be set so as not to be mixed with each other. A mixing state of the modulated light 103-1 and the modulated light 103-2 after being reflected by the reflection surface 150 of the curved mirror 15 can be set by adjusting an emission direction of the light 102 from the light source 11.

The 0th-order light remover 14 is disposed on an optical path of the modulated light 103. The 0th-order light remover 14 removes 0th-order light included in the modulated light 103. The modulated light 103 that has passed through the 0th-order light remover 14 does not include 0th-order light. The 0th-order light remover 14 includes a support member 140 and a light absorbing member 145.

The support member 140 is a member that supports the light absorbing member 145. The support member 140 fixes the light absorbing member 145 on the optical path of the 0th-order light included in the modulated light 103. For example, the support member 140 is made of a material such as glass or plastic that easily transmits the modulated light 103. When the support member 140 is made of plastic, it may use a material having a uniform entire surface and small phase unevenness so that retardation is less likely to occur. For example, a plastic material having suppressed birefringence is suitable for the support member 140. For example, the support member 140 may include a wire material for fixing the light absorbing member 145. For example, the peripheral edge of the support member 140 is formed in a frame shape, a wire material is stretched inside the opening of the frame, and the light absorbing member 145 can be fixed by the stretched wire material. In the case that the support member 140 is constructed with the wire material, a material in which the degradation hardly occurs due to the light may be used such that the degradation hardly occurs due to the irradiation of the modulated light 103, or a thin wire material may be used such that the passage of the modulated light 103 is hardly hindered.

The light absorbing member 145 is held on the optical path of the 0th-order light included in the modulated light 103 by the support member 140. In the configuration of the present example embodiment, the light absorbing member 145 is disposed on each optical path of the modulated light 103-1 and the modulated light 103-2. For example, a black body such as carbon is used for the light absorbing member 145. When the wavelength of the laser beam 101 to be used is fixed, the light absorbing member 145 made of a material that selectively absorbs light having the wavelength of the laser beam 101 may be used.

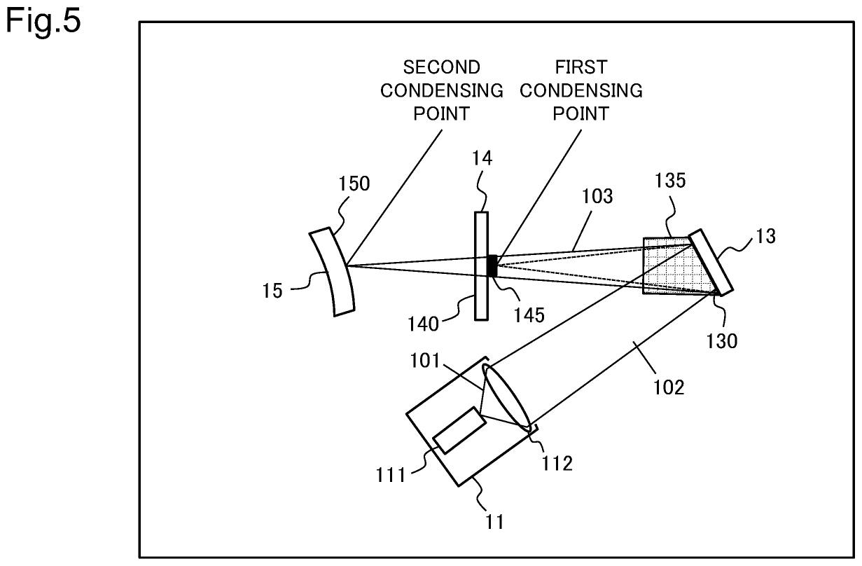

FIG. 5 is a conceptual diagram for explaining an example of a positional relationship between a condensing point (first condensing point) at which the 0th-order light is condensed and a condensing point (second condensing point) at which the modulated light 103 is condensed by the virtual lens image 1302. In the example of FIG. 5, the first condensing point is set at a position between the spatial light modulator 13 and the curved mirror 15. The 0th-order light remover 14 is disposed at the position of the first condensing point between the spatial light modulator 13 and the curved mirror 15. The light absorbing member 145 included in the 0th-order light remover 14 removes the 0th-order light included in the modulated light. The second condensing point is set on the reflection surface 150 of the curved mirror 15.
the curved mirror 15 is a reflecting mirror having the curved reflection surface 150. The reflection surface 150 is divided into the first reflection region 151 and the second reflection region 152. The first reflection region 151 is irradiated with the modulated light 103-1. The second reflection region 152 is irradiated with the modulated light 103-2. The reflection surface 150 of the curved mirror 15 has a curved surface/curvature relevant to the projection angle of the projection light 105. The curved surfaces/curvatures of the first reflection region 151 and the second reflection region 152 may be the same or different. The curved surfaces/curvatures of the first reflection region 151 and the second reflection region 152 are set according to traveling directions of the modulated light 103 and the projection light 105. For example, the reflection surface 150 of the curved mirror 15 may include a spherical surface. For example, the reflection surface 150 of the curved mirror 15 may include a free-curved surface. For example, the reflection surface 150 of the curved mirror 15 may have a shape in which a plurality of curved surfaces are combined instead of a single curved surface. For example, the reflection surface 150 of the curved mirror 15 may have a shape in which a curved surface and a flat surface are combined. For example, the curved mirror 15 having the first reflection region 151 and the curved mirror 15 having the second reflection region 152 may be combined. The curved mirror 15 may be configured such that the reflection surface 150 having the first reflection region 151 and the reflection surface 150 having the second reflection region 152 can be changed in any direction.

The curved mirror 15 is disposed on an optical path of the modulated light 103 with the reflection surface 150 facing the modulation part 130 of the spatial light modulator 13. The reflection surface 150 of the curved mirror 15 is irradiated with the modulated light 103 modulated by the modulation part 130 of the spatial light modulator 13. The light (projection light 105) reflected by the reflection surface 150 of the curved mirror 15 is enlarged and projected at an enlargement ratio corresponding to the curvature of the reflection surface 150. In the case of the example of FIG. 1, the projection light 105 is enlarged in the horizontal direction (the paper surface direction of FIG. 1) and the vertical direction (the up-down direction of the paper surface of FIG. 1) according to the curved surface/curvature of the irradiation range of the modulated light 103 on the reflection surface 150 of the curved mirror 15. The expansion direction of the projection light 105 may be either the horizontal direction or the vertical direction. The expansion direction of the projection light 105 may be a direction oblique to the horizontal direction or the vertical direction.

An image formed by the virtual lens image 1302 is displayed on the reflection surface 150 of the curved mirror 15. The modulated light 103 reflected by the reflection surface 150 of the curved mirror 15 is projected as the projection light 105. The shape of the image displayed on the reflection surface 150 of the curved mirror 15 and the shape of the image displayed on the projection target surface by the projection light 105 show mirror symmetry. When a projection optical system of a lens system such as a Fourier transform lens is used, efficiency is likely to decrease due to a large number of members constituting the lens, reflection/scattering of light on an incident surface and a reflection surface of the lens, partial loss of light due to vignetting, and the like. For example, in the configuration using the projection optical system, the efficiency is about 20%. When the curved mirror 15 is used without using the projection optical system of the lens system as in the present example embodiment, the efficiency can be suppressed to about 30%. That is, as compared with the configuration using the projection optical system, the light efficiency is improved in the case of using the curved mirror 15 as in the present example embodiment.

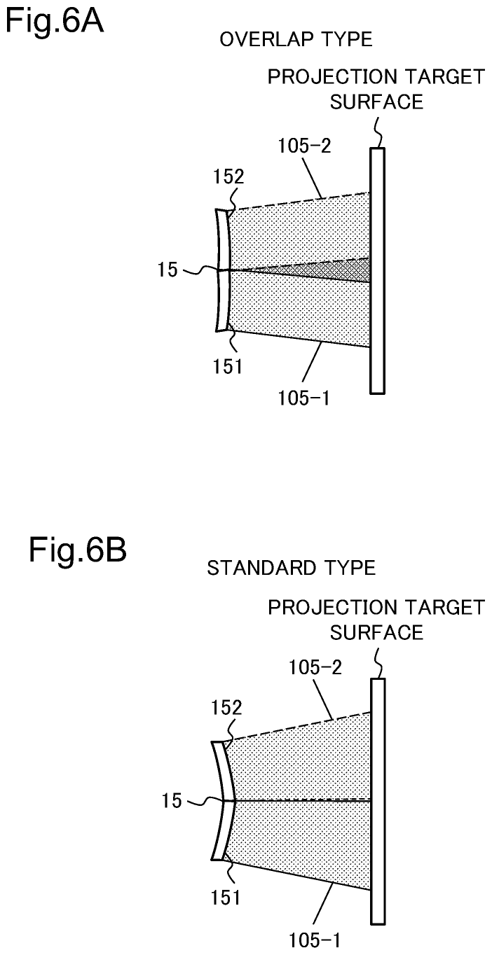

FIGS. 6A, 6B, and 6C are conceptual diagrams for explaining a projection pattern of the projection light 105 projected from the projection device 10. FIGS. 6A, 6B, and 6C are views of the curved mirror 15 disposed in the projection device 10 and a projection target surface as viewed from above. In FIGS. 6A, 6B, and 6C, the irradiation range of the projection light 105-1 (solid line) reflected by the first reflection region 151 and the projection range of the projection light 105-2 (broken line) reflected by the second reflection region 152 are indicated by hatching. Some projection patterns can be achieved by adjusting the emission axis of the light 102 emitted from the light source 11 in two directions and the reflection directions of the first reflection region 151 and the second reflection region 152. FIGS. 6A, 6B, and 6C exaggeratedly illustrate the projection pattern of the projection light 105, so that the positional relationship between the curved mirror 15 and the projection target surface is not accurate.

FIG. 6A illustrates a pattern (overlap type) in which the projection range of the projection light 105-1 and the projection range of the projection light 105-2 overlap each other on the projection target surface. In FIG. 6A, a state in which irradiation ranges of the projection light 105-1 and the projection light 105-2 overlap with each other is indicated by hatching. In the region where the irradiation ranges of the projection light 105-1 and the projection light 105-2 overlap, the luminance of light can be set higher than that in other regions. In an overlapping projection range of the projection light 105-1 and the projection light 105-2, the luminance of light is about 2 times as high as that of single projection light 105. For example, in an application in which light with high luminance is required, such as a case of inspecting a scratch or the like on a surface of an object, the projection light 105 may be projected in the overlap pattern of FIG. 6A.

FIG. 6B illustrates a pattern (standard type) in which the projection range of the projection light 105-1 and the projection range of the projection light 105-2 are adjacent to each other without overlapping each other on the projection target surface. The projection light 105 may be projected in the standard pattern of FIG. 6B in an application in which an image is displayed on the projection target surface or an application in which light having uniform luminance is required.

FIG. 6C illustrates a pattern (gap type) in which there is a gap between the projection range of the projection light 105-1 and the projection range of the projection light 105-2. In an application in which the projection light 105 is projected from single the single projection device 10 to different projection targets, the projection light 105 may be projected in a gap pattern in FIG. 6C.

### [Light Source]

Next, specific examples of the light source 11 included in the projection device 10 will be described with some examples. The light source 11 is configured to emit the light 102 in two directions. Here, a single example of the emitter 111 and two examples of the emitter 111 will be described.

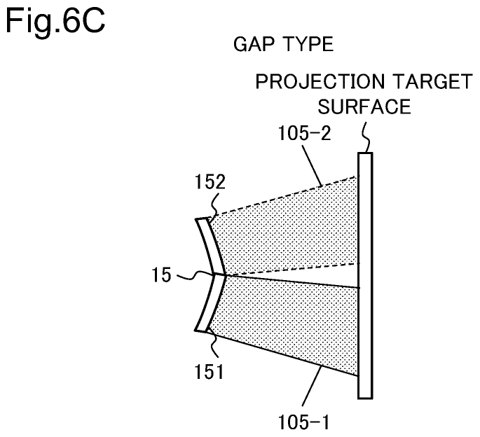

FIG. 7 illustrates a single example (light source 11-1) of the emitter 111. The light source 11-1 includes an emitter 111, a lens 112, a beam splitter 113, and an emission mirror 115. The beam splitter 113 and the emission mirror 115 constitute an optical system. The emitter 111 emits the laser beam 101 of a predetermined wavelength band toward the lens 112 under the control of the control unit 17. The lens 112 is disposed between the emitter 111 and the beam splitter 113. The lens 112 enlarges the laser beam 101 emitted from the emitter 111 in accordance with the size of the modulation part 130 of the spatial light modulator 13. The beam splitter 113 is disposed on an optical path of the light 102 enlarged by the lens 112. For example, the beam splitter 113 has a cube type or plate type structure. For example, a non-polar beam splitter can be used as the beam splitter 113. In a case where a non-polar beam splitter is used as the beam splitter 113, if a half mirror in which a ratio of the transmitted light to the reflected light is 1:1 is configured, the beam splitter can also be applied to coaxial epi-illumination which is one of illumination for inspection. For example, a polarization beam splitter can be used as the beam splitter 113. If a polarization beam splitter is used as the beam splitter 113, the laser beam 101 can be separated into s-polarized light and p-polarized light. In the light 102, the beam splitter 113 reflects a component (light 102-1) with which the first modulation region 131 is irradiated toward the emission mirror 115, and allows a component (light 102-2) with which the second modulation region 132 is irradiated to pass. The light having passed through the beam splitter 113 travels toward the second modulation region 132. The emission mirror 115 is disposed on an optical path of the light 102-1 reflected by the beam splitter 113 with a reflection surface facing the optical path. The reflection surface of the emission mirror 115 reflects the light 102-1 reflected by the beam splitter 113 toward the first modulation region 131.

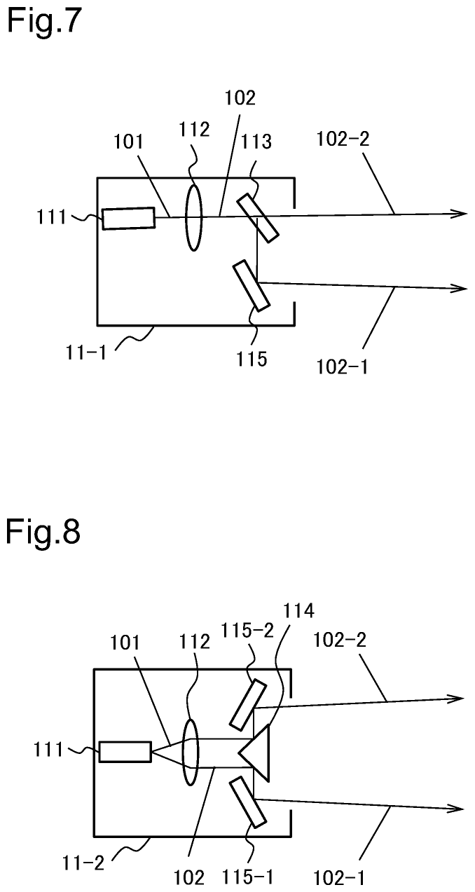

FIG. 8 illustrates a single example (light source 11-2) of the emitter 111. The light source 11-2 includes an emitter 111, a lens 112, a branching mirror 114, a first emission mirror 115-1, and a second emission mirror 115-2. The branching mirror 114, the first emission mirror 115-1, and the second emission mirror 115-2 constitute an optical system. The emitter 111 emits the laser beam 101 of a predetermined wavelength band toward the lens 112 under the control of the control unit 17. The lens 112 is disposed between the emitter 111 and the branching mirror 114. The lens 112 enlarges the laser beam 101 emitted from the emitter 111 in accordance with the size of the modulation part 130 of the spatial light modulator 13. The branching mirror 114 is disposed on an optical path of the light 102. For example, the branching mirror 114 is achieved by a right angle prism mirror in which a metal film is applied to two surfaces constituting a right angle of the right angle prism. When achieved by a right angle prism mirror, the right angle of the branching mirror 114 is arranged toward the lens 112. The branching mirror 114 reflects a component (light 102-1) emitted to the first modulation region 131 in the light 102 toward the first emission mirror 115-1. The branching mirror 114 reflects a component (light 102-2) emitted to the second modulation region 132 in the light 102 toward the second emission mirror 115-2. The first emission mirror 115-1 is disposed on the optical path of the light 102-1 reflected by the branching mirror 114 with the reflection surface facing the branching mirror 114. The reflection surface of the first emission mirror 115-1 reflects the light 102-1 reflected by the branching mirror 114 toward the first modulation region 131. The second emission mirror 115-2 is disposed on the optical path of the light 102-2 reflected by the branching mirror 114 with the reflection surface facing the branching mirror 114. The reflection surface of the second emission mirror 115-2 reflects the light 102-2 reflected by the branching mirror 114 toward the second modulation region 132.

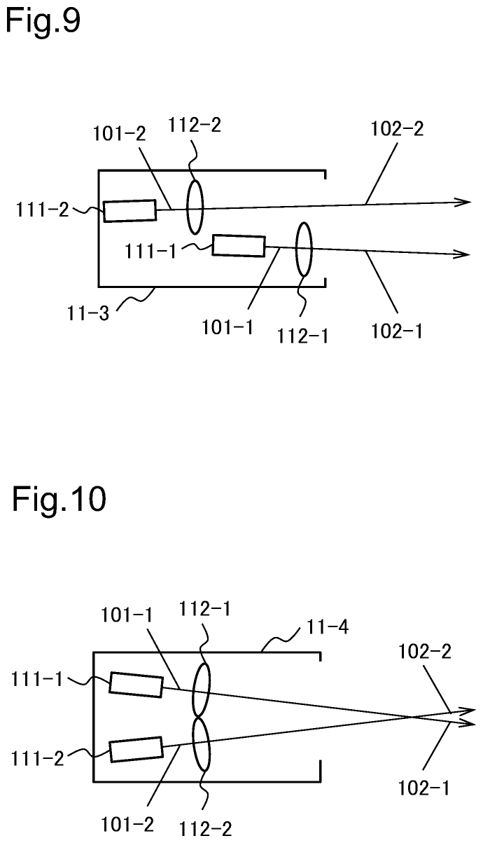

FIG. 9 illustrates an example in which the number of the emitters 111 is two (light source 11-3). The light source 11-1 includes a first emitter 111-1, a second emitter 111-2, a first lens 112-1, and a second lens 112-2. The first emitter 111-1 and the second emitter 111-2 are arranged such that the emission axes do not intersect each other. The first emitter 111-1 emits the laser beam 101-1 in a predetermined wavelength band toward the first lens 112-1 under the control of the control unit 17. The first lens 112-1 is disposed on an optical path of the laser beam 101-1 emitted from the first emitter 111-1. The first lens 112-1 enlarges the laser beam 101-1 emitted from the first emitter 111-1 according to the size of the first modulation region 131 of the modulation part 130 of the spatial light modulator 13. The light enlarged by the first lens 112-1 travels toward the first modulation region 131. The second emitter 111-2 emits the laser beam 101-2 in a predetermined wavelength band toward the second lens 112-2 under the control of the control unit 17. The wavelengths and outputs of the laser beam 101-1 and the laser beam 101-2 may be the same or different. The second lens 112-2 is disposed on an optical path of the laser beam 101-2 emitted from the second emitter 111-2. The second lens 112-2 enlarges the laser beam 101-2 emitted from the second emitter 111-2 according to the size of the second modulation region 132 of the modulation part 130 of the spatial light modulator 13. The light enlarged by the second lens 112-2 travels toward the second modulation region 132.

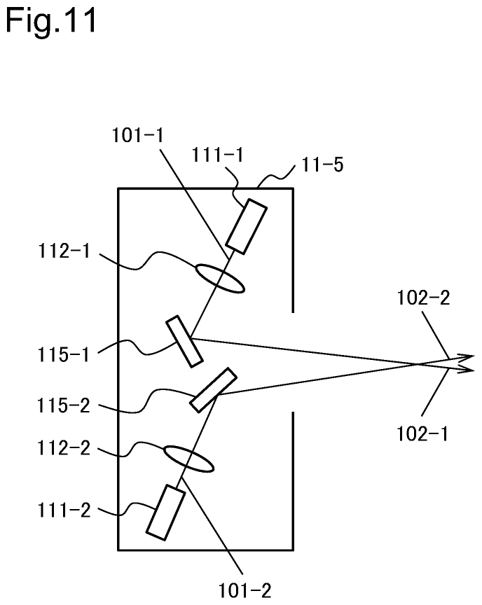

FIG. 10 illustrates an example in which the number of the emitters 111 is two (light source 11-4). The light source 11-1 includes a first emitter 111-1, a second emitter 111-2, a first lens 112-1, and a second lens 112-2. The first emitter 111-1 and the second emitter 111-2 are arranged such that emission axes thereof cross each other. The first emitter 111-1 emits the laser beam 101-1 in a predetermined wavelength band toward the first lens 112-1 under the control of the control unit 17. The first lens 112-1 is disposed on an optical path of the laser beam 101-1 emitted from the first emitter 111-1. The first lens 112-1 enlarges the laser beam 101-1 emitted from the first emitter 111-1 according to the size of the first modulation region 131 of the modulation part 130 of the spatial light modulator 13. The light enlarged by the first lens 112-1 travels toward the first modulation region 131. The second emitter 111-2 emits the laser beam 101-2 in a predetermined wavelength band toward the second lens 112-2 under the control of the control unit 17. The wavelengths and outputs of the laser beam 101-1 and the laser beam 101-2 may be the same or different. The second lens 112-2 is disposed on an optical path of the laser beam 101-2 emitted from the second emitter 111-2. The second lens 112-2 enlarges the laser beam 101-2 emitted from the second emitter 111-2 according to the size of the second modulation region 132 of the modulation part 130 of the spatial light modulator 13. The light enlarged by the second lens 112-2 travels toward the second modulation region 132.

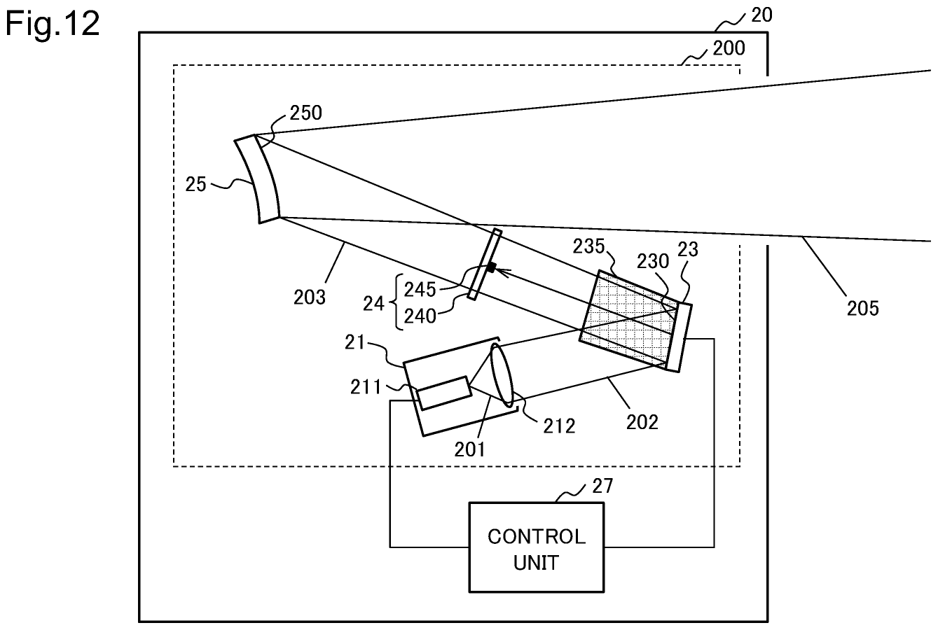

FIG. 11 illustrates an example in which the number of the emitters 111 is two (light source 11-5). The light source 11-1 includes a first emitter 111-1, a second emitter 111-2, a first lens 112-1, a second lens 112-2, a first emission mirror 115-1, and a second emission mirror 115-2. The first emission mirror 115-1 and the second emission mirror 115-2 constitute an optical system. The first emitter 111-1 and the second emitter 111-2 are disposed such that emission surfaces of the laser beams 101 face each other. The first emitter 111-1 emits the laser beam 101-1 in a predetermined wavelength band toward the first lens 112-1 under the control of the control unit 17. The first lens 112-1 is disposed on an optical path of the laser beam 101-1 emitted from the first emitter 111-1. The first lens 112-1 enlarges the laser beam 101-1 emitted from the first emitter 111-1 according to the size of the first modulation region 131 of the modulation part 130 of the spatial light modulator 13. The light 102-1 enlarged by the first lens 112-1 travels toward the first emission mirror 115-1. The first emission mirror 115-1 is disposed on an optical path of the light 102-1 enlarged by the first lens 112-1 with a reflection surface facing the first lens 112-1. The first emission mirror 115-1 reflects the light 102-1 enlarged by the first lens 112-1 toward the first modulation region 131. The light 102-1 reflected by the first emission mirror 115-1 travels toward the first modulation region 131. The second emitter 111-2 emits the laser beam 101-2 in a predetermined wavelength band toward the second lens 112-2 under the control of the control unit 17. The wavelengths and outputs of the laser beam 101-1 and the laser beam 101-2 may be the same or different. The second lens 112-2 is disposed on an optical path of the laser beam 101-2 emitted from the second emitter 111-2. The second lens 112-2 enlarges the laser beam 101-2 emitted from the second emitter 111-2 according to the size of the second modulation region 132 of the modulation part 130 of the spatial light modulator 13. The light 102-2 enlarged by the second lens 112-2 travels toward the second emission mirror 115-2. The second emission mirror 115-2 is disposed on the optical path of the light 102-2 enlarged by the second lens 112-2 with the reflection surface facing the second lens 112-2. The second emission mirror 115-2 reflects the light 102-2 enlarged by the second lens 112-2 toward the second modulation region 132. The light 102-2 reflected by the second emission mirror 115-2 travels toward the second modulation region 132.

The light sources 11-3 to 11-5 having the configurations of FIGS. 9 to 11 can emit light of a desired output by combining the emitters 111 having weak outputs. For example, the light sources 11-3 to 11-5 can obtain a power of 9.0 mW using two 4.5 milliwatt (mW) emitters 111. That is, in the case of the configurations of FIGS. 9 to 11, since the substantial laser classes of the light sources 11-3 to 11-5 can be lowered, it is possible to project high-output projection light while clearing the legal standard.

As described above, the projection device of the present example embodiment includes the light source, the spatial light modulator, the partition wall, the 0th-order light remover, the control unit, and the curved mirror. The spatial light modulator includes a modulation part in which two modulation regions irradiated with light emitted from a light source are set. The spatial light modulator modulates the phase of the emitted light in each of the two modulation regions set in the modulation part. The partition wall is disposed at a boundary between the two modulation regions. The partition wall separates the modulated light modulated by each of the two modulation regions. The 0th-order light remover includes two light absorbing members associated with two modulation regions set in the modulation part of the spatial light modulator, and a support member that supports the two light absorbing members. Each of the two light absorbing members is disposed in an optical path of the 0th-order light included in modulated light modulated in the associated modulation region. Each of the two light absorbing members removes the 0th-order light included in the modulated light modulated in the associated modulation region. The control unit sets a pattern for forming a desired image in each of the two modulation regions set in the modulation part of the spatial light modulator. The control unit controls the light source so that the modulation part in which the pattern is set is irradiated with light. The curved mirror has a curved reflection surface irradiated with the modulated light modulated for every two modulation regions set in the modulation part of the spatial light modulator. The curved mirror reflects the modulated light on the reflection surface, and projects projection light having an enlarged projection angle according to the curvature of the reflection surface.

Since the projection device of the present example embodiment does not include a projection optical system such as a Fourier transform lens or a projection lens, it can be configured compactly. The projection device of the present example embodiment sets a pattern for each projection range in two modulation regions set in the modulation part of the spatial light modulator. Therefore, according to the projection device of the present example embodiment, the projection light can be projected toward a wide range including two projection ranges. In the projection device of the present example embodiment, since the partition wall is disposed at the boundary between the two modulation regions, the modulated light modulated in the different modulation regions is not mixed immediately after emission. Therefore, according to the projection device of the present example embodiment, it is possible to prevent higher-order light associated with a desired image from being projected on an adjacent projection range. Furthermore, since the projection device of the present example embodiment removes the 0th-order light included in the modulated light, the 0th-order light is not projected in the projection range. That is, according to the projection device of the present example embodiment, projection light not including an unnecessary light component can be projected over a wide range while having a compact configuration.

In one aspect of the present example embodiment, the partition wall is disposed to stand substantially perpendicular to the modulation part of the spatial light modulator at all boundaries of the two modulation regions. According to the present aspect, since the partition walls are erected at all the boundaries of the two modulation regions, the higher-order light of the desired image is hardly displayed on the projection target surface.

In one aspect of the present example embodiment, the control unit sets a composite image obtained by combining a phase image for forming a desired image and a virtual lens image for condensing modulated light for forming a desired image on the reflection surface of the curved mirror, in each of the two modulation regions set in the modulation part of the spatial light modulator. According to the present aspect, since the condensing position of the virtual lens image is installed on the reflection surface of the curved mirror, the desired image can be displayed more clearly on the projection target surface.

In one aspect of the present example embodiment, the light source includes an emitter, a lens, and an optical system. The emitter emits light. The lens enlarges the light emitted from the emitter in accordance with the size of the modulation part of the spatial light modulator. The optical system divides and emits the light enlarged by the lens toward each of the two modulation regions. According to the present aspect, it is possible to achieve a light source that emits light toward two modulation regions using a single emitter.

In one aspect of the present example embodiment, the light source includes two emitters and two lenses. Each of the two emitters is associated with one of the two modulation regions. Each of the two emitters is disposed with the emission axis facing the associated modulation region. Each of the two emitters emits light. Each of the two lenses is disposed in association with each of the two emitters. Each of the two lenses enlarges the light emitted from the associated emitter in accordance with the size of the modulation part of the spatial light modulator. The projection device of this aspect does not include an optical system that divides light. Therefore, according to the present aspect, since light loss does not occur in the optical system, the efficiency of light emitted from the light source can be improved.

In one aspect of the present example embodiment, the curved mirror is associated with two modulation regions, and the reflection surface is divided into two reflection regions. The curved mirror is disposed at a position where the modulated light modulated in each of the two modulation regions is reflected by the reflection region associated with the modulated light. According to the present aspect, by dividing the reflection surface of the curved mirror into the two reflection regions, the projection light based on the modulated light modulated in each of the two modulation regions can be more accurately projected toward the desired projection range.

In one aspect of the present example embodiment, in the curved mirror, two reflection regions are set such that projection ranges of projection light reflected by the two reflection regions overlap each other on the projection target surface. In this aspect, a region where projection light projected toward two projection ranges overlaps each other is formed. Therefore, according to the present aspect, it is possible to project high luminance light in a region where projection light projected toward two projection ranges overlaps each other.

In one aspect of the present example embodiment, in the curved mirror, two reflection regions are set such that projection ranges of projection light reflected by the two reflection regions do not overlap each other on the projection target surface. In the present example embodiment, a region where projection light projected toward two projection ranges overlaps each other is not formed. When a region where projection light projected toward two projection ranges overlaps with each other is unexpectedly formed, there is a possibility that high luminance light is projected on a region where the luminance is desired to be set low. According to the present aspect, since the region where the projection light projected toward the two projection ranges overlaps with each other is not formed, it is possible to prevent occurrence of an unexpected high luminance region.

In one aspect of the present example embodiment, in the curved mirror, two reflection regions are set such that projection ranges of projection light reflected by the two reflection regions are adjacent to each other on the projection target surface. In the present aspect, the projection light reflected by the two reflection regions is projected on projection ranges adjacent to each other. Therefore, according to the present aspect, a seamless image and continuous display information can be formed in adjacent projection ranges.

### Second Example Embodiment

Next, a projection device according to a second example embodiment will be described with reference to the drawings. In the projection device of this example embodiment, the modulation part of the spatial light modulator is divided into three modulation regions, and the projection light is projected in three directions. Hereinafter, an example in which the modulation part of the spatial light modulator is divided into three in the longitudinal direction will be described. The modulation part may be divided into three parts in the lateral direction.

### (Configuration)

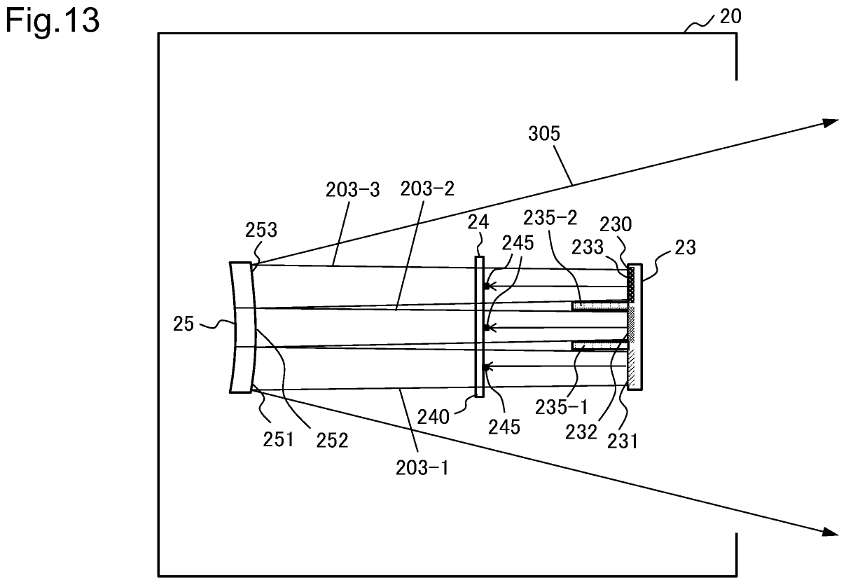

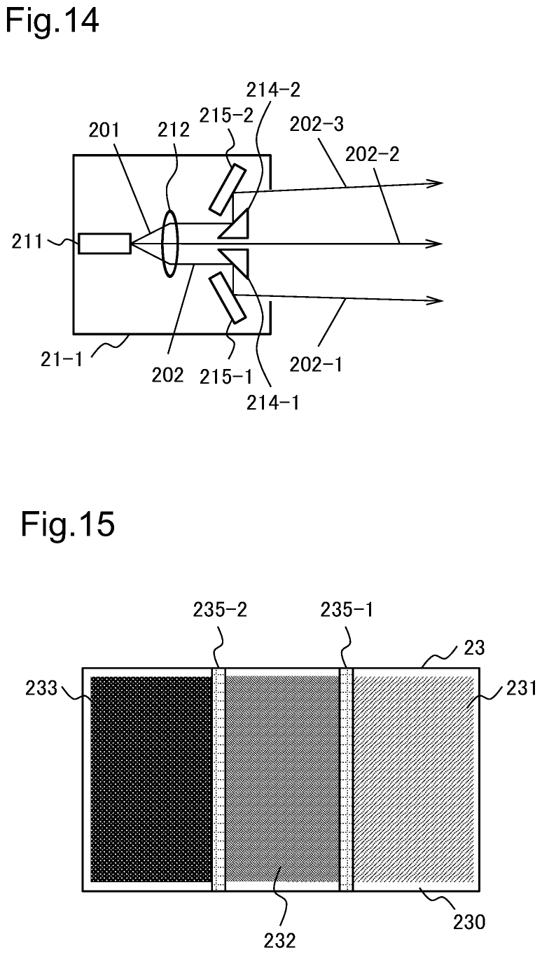

FIGS. 12 and 13 are conceptual diagrams illustrating an example of a configuration of a projection device 20 according to the present example embodiment. The projection device 20 includes a light source 21, a spatial light modulator 23, a 0th-order light remover 24, a curved mirror 25, and a control unit 27. The light source 21, the spatial light modulator 23, the 0th-order light remover 24, and the curved mirror 25 constitute a projection unit 200. FIG. 12 is a side view illustrating an internal configuration of the projection device 20 as viewed from the lateral direction. FIG. 13 is a side view illustrating the internal configuration of the projection device 20 as viewed from above. In FIG. 13, the light source 21 is omitted. FIGS. 12 and 13 are conceptual, and do not accurately represent a positional relationship between components, a traveling direction of light, and the like.

The light source 21 includes an emitter 211 and a lens 212. The light source 21 emits a laser beam 201 in three directions. Specifically, the laser beam 201 emitted from the light source 21 in the three directions is emitted to each of the three modulation regions (first modulation region 231, second modulation region 232, and third modulation region 233) set in and modulation part 230 of the spatial light modulator 23. As the light source 21, a configuration including one emitter 211 and one lens 212 or a configuration including three emitters 211 and three lenses 212 can be selected. A configuration example of the light source 21 will be described later.

The emitter 211 has the same configuration as the emitter 111 of the first example embodiment. The emitter 211 emits laser beam 201 in a predetermined wavelength band under the control of the control unit 27. The lens 212 enlarges the laser beam 201 emitted from the emitter 211 in accordance with the size of the modulation part 230 of the spatial light modulator 23. The laser beam 201 emitted from the emitter 211 is enlarged by the lens 212 and emitted from the light source 21. The light 202 emitted from the light source 21 travels toward the modulation part 230 of the spatial light modulator 23.

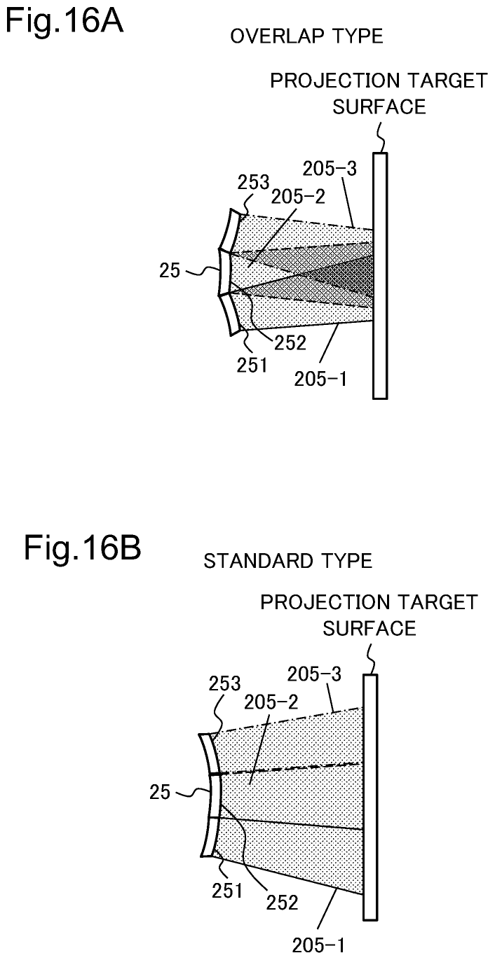

FIG. 14 illustrates a single example (light source 21-1) of the emitter 211. The light source 21-1 includes an emitter 211, a lens 212, a first branching mirror 214-1, a second branching mirror 214-2, a first emission mirror 215-1, and a second emission mirror 215-2. The first branching mirror 214-1, the second branching mirror 214-2, the first emission mirror 215-1, and the second emission mirror 215-2 constitute an optical system. In order to pass a part of the light 202 that has passed through the lens 212, the first branching mirror 214-1 and the second branching mirror 214-2 are arranged at an interval. For example, the first branching mirror 214-1 and the second branching mirror 214-2 are achieved by a right angle prism mirror in which a metal film is formed on an inclined surface that does not form a right angle of the right angle prism. In the case of being achieved by the right angle prism mirror, the inclined surfaces of the first branching mirror 214-1 and the second branching mirror 214-2 are arranged toward the lens 212 and the first emission mirror 215-1 and the second emission mirror 215-2. The light source 21 may be achieved not by the configuration of FIG. 14 but by combining the configurations (FIGS. 7 to 11) shown in the first example embodiment. For example, three emitters 211 may be used to emit the laser beam 201 in three directions.

The emitter 211 emits the laser beam 201 of a predetermined wavelength band toward the lens 212 under the control of the control unit 27. The lens 212 is disposed on an optical path of the laser beam 201 emitted from the emitter 211. The lens 212 enlarges the laser beam 201 emitted from the emitter 211 in accordance with the size of the modulation part 230 of the spatial light modulator 23. The first branching mirror 214-1 is disposed on an optical path of the light 202 enlarged by the lens 212. The first branching mirror 214-1 reflects a component (light 202-1) emitted to the first modulation region 231 in the light 202 toward the first emission mirror 215-1. The first emission mirror 215-1 is disposed on the optical path of the light 202-1 reflected by the first branching mirror 214-1 with the reflection surface facing the first branching mirror 214-1. The reflection surface of the first emission mirror 215-1 reflects the light 202-1 reflected by the first branching mirror 214-1 toward the first modulation region 231. A part of the light 202 (light 202-2) that has passed through the lens 212 passes through the gap between the first branching mirror 214-1 and the second branching mirror 214-2 and travels toward the second modulation region 232. The second branching mirror 214-2 is disposed on the optical path of the light 202 enlarged by the lens 212. The second branching mirror 214-2 reflects a component (light 202-3) emitted to the third modulation region 233 in the light 202 toward the second emission mirror 215-2. The second emission mirror 215-2 is disposed on the optical path of the light 202-3 reflected by the second branching mirror 214-2 with the reflection surface facing the second branching mirror 214-2. The reflection surface of the second emission mirror 215-2 reflects the light 202-3 reflected by the second branching mirror 214-2 toward the third modulation region 233.

The spatial light modulator 23 has the same configuration as the spatial light modulator 13 of the first example embodiment. The spatial light modulator 23 includes a modulation part 230 irradiated with the light 202. In the modulation part 230, the first modulation region 231, the second modulation region 232, and the third modulation region 233 are set. A first partition wall 235-1 is disposed between the first modulation region 231 and the second modulation region 232. A second partition wall 235-2 is disposed between the second modulation region 232 and the third modulation region 233. The first partition wall 235-1 and the second partition wall 235-2 stand perpendicularly to the surface of the modulation part 230. The first partition wall 235-1 and the second partition wall 235-2 divide the modulation part 230 by three. The first partition wall 235-1 divides the first modulation region 231 and the second modulation region 232 such that a modulated light 203-1 modulated in the first modulation region 231 and a modulated light 203-2 modulated in the second modulation region 232 are not mixed immediately after being modulated by the modulation part 230. The second partition wall 235-2 divides the second modulation region 232 and the third modulation region 233 such that the modulated light 203-2 modulated in the second modulation region 232 and a modulated light 203-3 modulated in the third modulation region 233 are not mixed immediately after being modulated by the modulation part 230. A pattern corresponding to the image displayed by a projection light 205 is set in each of the first modulation region 231, the second modulation region 232, and the third modulation region 233 under the control of the control unit 27.

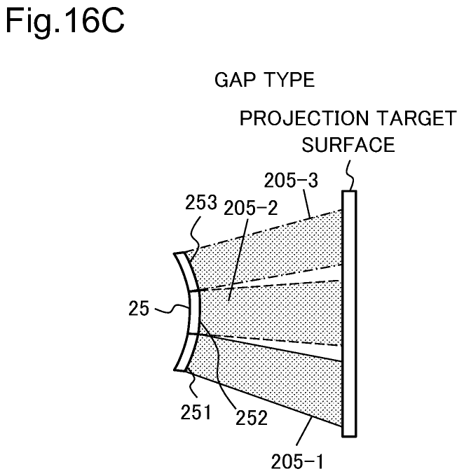

FIG. 15 is an example of the first modulation region 231, the second modulation region 232, and the third modulation region 233 set in the modulation part 230 of the spatial light modulator 23. A pattern (phase image) related to an image formed by the modulated light 203-1 is set in the first modulation region 231. A phase image related to an image formed by the modulated light 203-2 is set in the second modulation region 232. A phase image related to an image formed by the modulated light 203-3 is set in the third modulation region 233. For example, in a case where only one of the modulated light 203-1, the modulated light 203-2, and the modulated light 203-3 is used for image display, the phase image may be set only in the modulation region from which the modulated light 203 used for image display is emitted.

The modulated light 203-1 modulated in the first modulation region 231 and the modulated light 203-2 modulated in the second modulation region 232 are separated by the first partition wall 235-1 immediately after being emitted from the modulation part 230. The modulated light 203-2 modulated in the second modulation region 232 and the modulated light 203-3 modulated in the third modulation region 233 are separated by the second partition wall 235-2 immediately after being emitted from the modulation part 230. The modulated light 203-1, the modulated light 203-2, and the modulated light 203-3 can be set to be mixed with each other or not mixed with each other after being reflected by the reflection surface 250 of the curved mirror 25. A mixing state of the modulated light 203-1, the modulated light 203-2, and the modulated light 203-3 after being reflected by the reflection surface 250 of the curved mirror 25 can be set by adjusting an emission direction of the light 202 from the light source 21.

The 0th-order light remover 24 is disposed on an optical path of the modulated light 203. The 0th-order light remover 24 removes the 0th-order light included in the modulated light 203. The modulated light 203 that has passed through the 0th-order light remover 24 does not include the 0th-order light. The 0th-order light remover 24 includes a support member 240 and a light absorbing member 245. The support member 240 is similar to the support member 140 of the first example embodiment. The light absorbing member 245 is held on the optical path of the 0th-order light included in the modulated light 203 by the support member 240. In the configuration of the present example embodiment, the light absorbing member 245 is disposed on each optical path of the modulated light 203-1, the modulated light 203-2, and the modulated light 203-3. The material of the light absorbing member 245 is similar to that of the light absorbing member 145 of the first example embodiment.

The curved mirror 25 has the same configuration as the curved mirror 15 of the first example embodiment. The curved mirror 25 is a reflecting mirror having the curved reflection surface 250. The reflection surface 250 is divided into a first reflection region 251, a second reflection region 252, and a third reflection region 253. The first reflection region 251 is irradiated with the modulated light 203-1. The second reflection region 252 is irradiated with the modulated light 203-2. The third reflection region 253 is irradiated with the modulated light 203-3. The reflection surface 250 of the curved mirror 25 has a curved surface/curvature relevant to the projection angle of the projection light 205. The curved surfaces/curvatures of the first reflection region 251, the second reflection region 252, and the third reflection region 253 may be the same or different. The curved surfaces/curvatures of the first reflection region 251, the second reflection region 252, and the third reflection region 253 are set according to the traveling directions of the modulated light 203 and the projection light 205. For example, the curved mirror 25 having the first reflection region 251, the curved mirror 25 having the second reflection region 252, and the curved mirror 25 having the first reflection region 251 may be combined. The curved mirror 25 may be configured such that the reflection direction of the reflection surface 250 having the first reflection region 251, the reflection surface 250 having the second reflection region 252, and the reflection surface 250 having the third reflection region 253 can be changed.

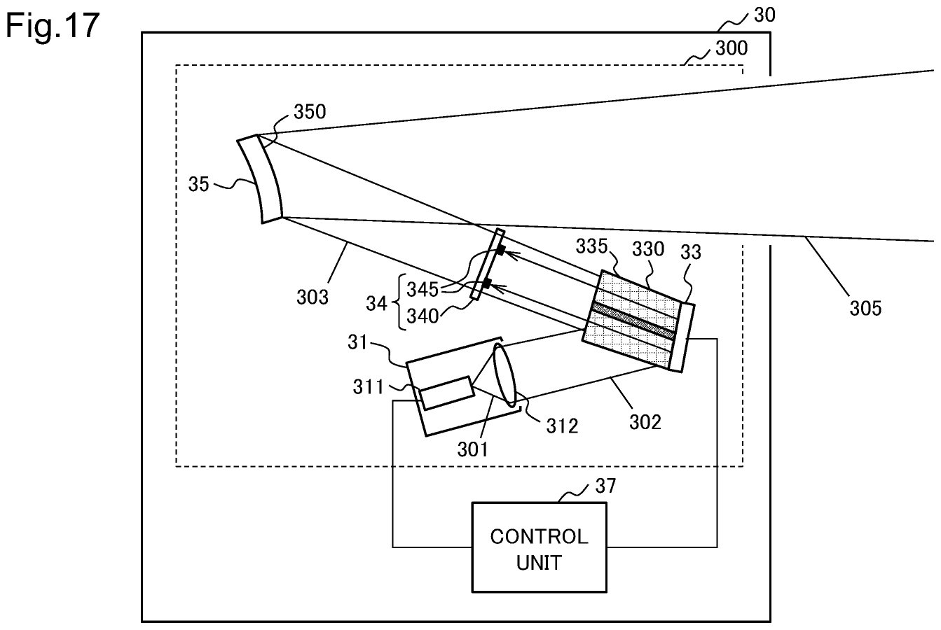

FIGS. 16A, 16B, and 16C are conceptual diagrams for explaining a projection pattern of the projection light 205 projected from the projection device 20. FIGS. 16A, 16B, and 16C are views of the curved mirror 25 disposed in the projection device 20 as viewed from above. In FIGS. 16A, 16B, and 16C, the projection ranges of projection light 205-1 (solid line) reflected by the first reflection region 251, projection light 205-2 (broken line) reflected by the second reflection region 252, and projection light 205-3 (alternate long and short dash line) reflected by the third reflection region 253 are indicated by hatching. Some projection patterns can be achieved by adjusting emission axes of the light 202 emitted from the light source 21 in three directions and the reflection directions of the first reflection region 251, the second reflection region 252, and the third reflection region 253. FIGS. 16A, 16B, and 16C illustrate the projection pattern of the projection light 205 in an exaggerated manner, so that the positional relationship between the curved mirror 25 and the projection target surface is not accurate.

FIG. 16A illustrates a pattern (overlap type) in which projection ranges of the projection lights 205-1 to 205-3 overlap each other on a projection target surface. In FIG. 16A, a state in which the projection ranges of the projection lights 205-1 to 205-3 overlap with each other is indicated by hatching. In the case of FIG. 16A, there are three patterns in which projection ranges of the projection light 205 overlap each other. The first pattern is a pattern in which the projection ranges of the projection light 205-1 and the projection light 205-2 overlap each other. The second pattern is a pattern in which the projection ranges of the projection light 205-2 and the projection light 205-3 overlap each other. The third pattern is a pattern in which the projection ranges of the projection lights 205-1 to 205-3 overlap each other. In a projection range where the projection light 205 overlaps in the first pattern and the second pattern, the luminance of light is higher than that of single projection light. In the projection range in which the projection light 205 overlaps in the third pattern, the luminance of light can be set higher than that in the projection range in which the projection light 205 overlaps in the first pattern and the second pattern. In the fifth pattern, in the projection range where the projection lights 205-1 to 205-3 overlap, the luminance of the light is about 3 times as large as that of the single projection light. For example, in an application in which light with high luminance is required, such as a case of inspecting a scratch or the like on the surface of an object, the projection light 205 may be projected in the overlapping pattern of FIG. 16A.

FIG. 16B illustrates a pattern (standard type) in which the projection ranges of the projection lights 205-1 to 205-3 are adjacent to each other without overlapping each other on the projection target surface. The projection light 205 may be projected in the standard pattern of FIG. 16B in an application in which an image is displayed on the projection target surface or an application in which light having uniform luminance is required.

FIG. 16C illustrates a pattern (gap type) in which there is a gap between the projection ranges of the projection lights 205-1 to 205-3. In an application in which the projection light 205 is projected from single the single projection device 20 to different projection targets, the projection light 205 may be projected in a gap pattern in FIG. 16C.

As described above, the projection device of the present example embodiment includes the light source, the spatial light modulator, the partition wall, the 0th-order light remover, the control unit, and the curved mirror. The spatial light modulator includes a modulation part in which three modulation regions irradiated with light emitted from a light source are set. The spatial light modulator modulates the phase of the emitted light in each of the three modulation regions set in the modulation part. The partition wall is disposed at a boundary between the three modulation regions. The partition wall separates the modulated light modulated by each of the three modulation regions. The 0th-order light remover includes three light absorbing members associated with three modulation regions set in the modulation part of the spatial light modulator, and a support member that supports the three light absorbing members. Each of the three light absorbing members is disposed in an optical path of the 0th-order light included in modulated light modulated in the associated modulation region. Each of the three light absorbing members removes the 0th-order light included in the modulated light modulated in the associated modulation region. The control unit sets a pattern for forming a desired image in each of the three modulation regions set in the modulation part of the spatial light modulator. The control unit controls the light source so that the modulation part in which the pattern is set is irradiated with light. The curved mirror has a curved reflection surface. The curved reflection surface is irradiated with modulated light modulated for each of the three modulation regions set in the modulation part of the spatial light modulator. The curved mirror reflects the modulated light on the reflection surface, and projects projection light having an enlarged projection angle according to the curvature of the reflection surface.

Since the projection device of the present example embodiment does not include a projection optical system such as a Fourier transform lens or a projection lens, it can be configured compactly. The projection device of the present example embodiment sets a pattern for each projection range in three modulation regions set in the modulation part of the spatial light modulator. Therefore, according to the projection device of the present example embodiment, the projection light can be projected toward a wide range including three projection ranges. In the projection device of the present example embodiment, since the partition wall is disposed at the boundary between the three modulation regions, the modulated light modulated in the different modulation regions is not mixed immediately after emission. Therefore, according to the projection device of the present example embodiment, it is possible to prevent higher-order light associated with a desired image from being projected on an adjacent projection range. Furthermore, since the projection device of the present example embodiment removes the 0th-order light included in the modulated light, the 0th-order light is not projected in the projection range. That is, according to the projection device of the present example embodiment, projection light not including an unnecessary light component can be projected over a wide range while having a compact configuration.

In one aspect of the present example embodiment, the partition wall is disposed to stand substantially perpendicular to the modulation part of the spatial light modulator at all boundaries of the three modulation regions. According to the present aspect, since the partition walls are erected at all the boundaries of the three modulation regions, the higher-order light of the desired image is hardly displayed on the projection target surface.

In one aspect of the present example embodiment, the control unit sets a composite image obtained by combining a phase image for forming a desired image and a virtual lens image for condensing modulated light for forming a desired image on the reflection surface of the curved mirror, in each of the three modulation regions set in the modulation part of the spatial light modulator. According to the present aspect, since the condensing position of the virtual lens image is installed on the reflection surface of the curved mirror, the desired image can be displayed more clearly on the projection target surface.

In one aspect of the present example embodiment, the light source includes an emitter, a lens, and an optical system. The emitter emits light. The lens enlarges the light emitted from the emitter in accordance with the size of the modulation part of the spatial light modulator. The optical system divides and emits the light enlarged by the lens toward each of the three modulation regions. According to the present aspect, it is possible to achieve a light source that emits light toward three modulation regions using a single emitter.

In one aspect of the present example embodiment, the light source includes three emitters and three lenses. Each of the three emitters is associated with one of the three modulation regions. Each of the three emitters is disposed with the emission axis facing the associated modulation region. Each of the three emitters emits light. Each of the three lenses is disposed in association with each of the three emitters. Each of the three lenses enlarges the light emitted from the associated emitter in accordance with the size of the modulation part of the spatial light modulator. The projection device of this aspect does not include an optical system that divides light. Therefore, according to the present aspect, since light loss does not occur in the optical system, the efficiency of light emitted from the light source can be improved.

In one aspect of the present example embodiment, the curved mirror is associated with three modulation regions, and the reflection surface is divided into three reflection regions. The curved mirror is disposed at a position where the modulated light modulated in each of the three modulation regions is reflected by the reflection region associated with the modulated light. According to the present aspect, by dividing the reflection surface of the curved mirror into the three reflection regions, the projection light based on the modulated light modulated in each of the three modulation regions can be more accurately projected toward the desired projection range.

In one aspect of the present example embodiment, in the curved mirror, three reflection regions are set such that projection ranges of projection light reflected by the three reflection regions overlap each other on the projection target surface. In this aspect, a region where projection light projected toward three projection ranges overlaps each other is formed. Therefore, according to the present aspect, it is possible to project high luminance light in a region where projection light projected toward three projection ranges overlaps each other.

In one aspect of the present example embodiment, in the curved mirror, three reflection regions are set such that projection ranges of projection light reflected by the three reflection regions do not overlap each other on the projection target surface. In the present example embodiment, a region where projection light projected toward three projection ranges overlaps each other is not formed. When a region where projection light projected toward three projection ranges overlaps with each other is unexpectedly formed, there is a possibility that high luminance light is projected on a region where the luminance is desired to be set low. According to the present aspect, since the region where the projection light projected toward the three projection ranges overlaps with each other is not formed, it is possible to prevent occurrence of an unexpected high luminance region.

In one aspect of the present example embodiment, in the curved mirror, three reflection regions are set such that projection ranges of projection light reflected by the three reflection regions are adjacent to each other on the projection target surface. In the present aspect, the projection light reflected by the three reflection regions is projected on projection ranges adjacent to each other. Therefore, according to the present aspect, a seamless image and continuous display information can be formed in adjacent projection ranges.

### Third Example Embodiment

Next, a projection device according to a third example embodiment will be described with reference to the drawings. In the projection device of this example embodiment, the modulation part of the spatial light modulator is divided into four modulation regions, and the projection light is projected in four directions. Hereinafter, an example in which the modulation part of the spatial light modulator is divided into four parts by a cross will be described. The modulation part may be divided into four in the longitudinal direction or the lateral direction.

### (Configuration)

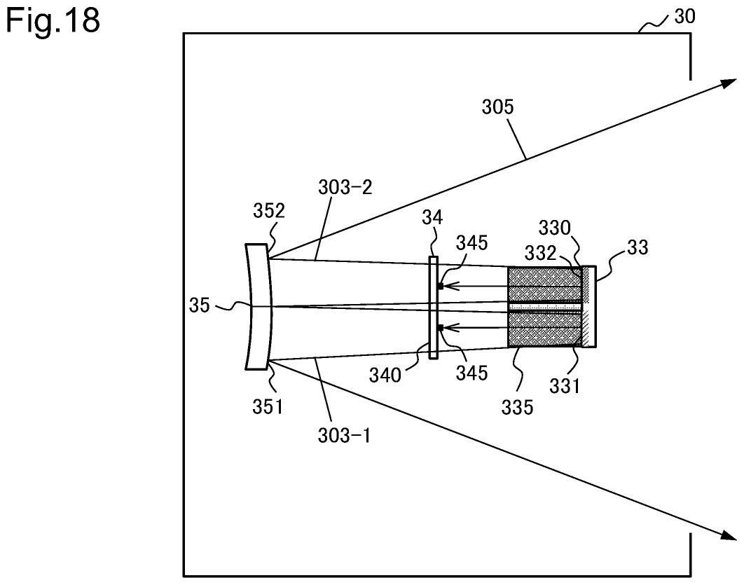

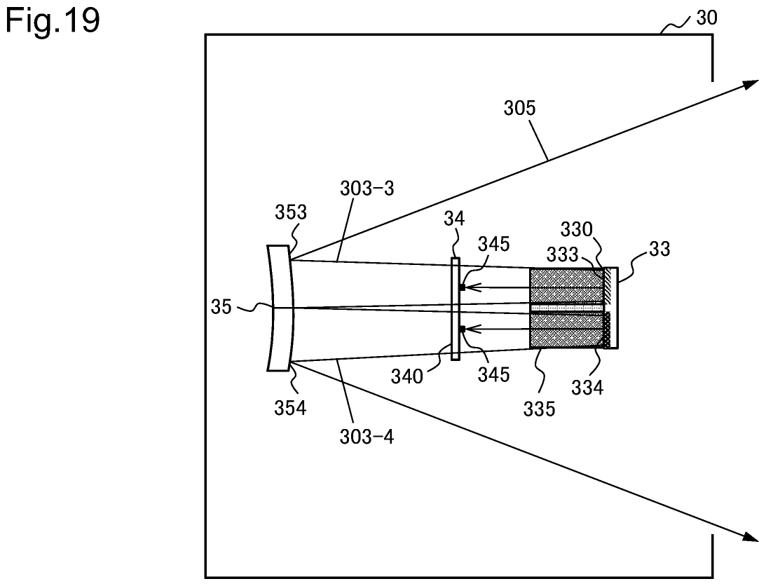

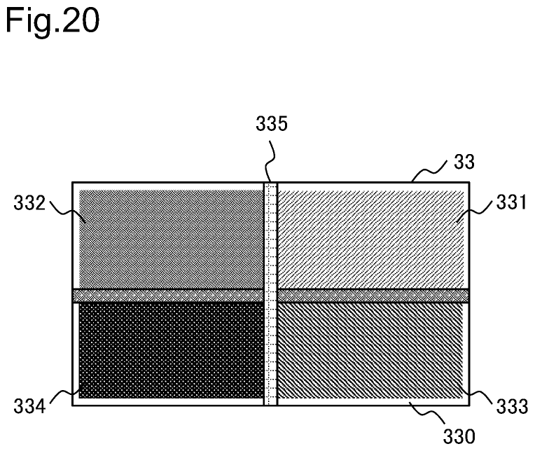

FIGS. 17 to 19 are conceptual diagrams illustrating an example of a configuration of a projection device 30 according to the present example embodiment. The projection device 30 includes a light source 31, a spatial light modulator 33, a 0th-order light remover 34, a curved mirror 35, and a control unit 37. The light source 31, the spatial light modulator 33, the 0th-order light remover 34, and the curved mirror 35 constitute a projection unit 300. FIG. 17 is a side view illustrating an internal configuration of the projection device 30 as viewed from the lateral direction. FIG. 18 is a side view illustrating the internal configuration of the projection device 30 as viewed from above. FIG. 19 is a side view illustrating an internal configuration of the projection device 30 as viewed from below. In FIGS. 18 and 19, the light source 31 is omitted. FIGS. 17 to 19 are conceptual, and do not accurately represent a positional relationship between components, a traveling direction of light, and the like.

The light source 31 includes an emitter 311 and a lens 312. The light source 31 emits a laser beam 301 in four directions. Specifically, the laser beam 301 emitted from the light source 31 in the four directions is emitted to each of the four modulation regions (first modulation region 331, second modulation region 332, third modulation region 333, and fourth modulation region 334) set in a modulation part 330 of the spatial light modulator 33. As the light source 31, a configuration including one emitter 311 and one lens 312 or a configuration including a plurality of emitters 311 and a plurality of lenses 312 can be selected. The drawing of a configuration example of the light source 31 is omitted. For example, when two light sources 11-1 to 11-5 in FIGS. 7 to 11 are combined, it is possible to achieve a configuration in which the laser beam 301 is emitted in four directions.

The emitter 311 has the same configuration as the emitter 111 of the first example embodiment. The emitter 311 emits laser beam 301 in a predetermined wavelength band under the control of the control unit 37. The lens 312 enlarges the laser beam 301 emitted from the emitter 311 in accordance with the size of the modulation part 330 of the spatial light modulator 33. The laser beam 301 emitted from the emitter 311 is enlarged by the lens 312 and emitted from the light source 31. The light 302 emitted from the light source 31 travels toward the modulation part 330 of the spatial light modulator 33.

The spatial light modulator 33 has the same configuration as the spatial light modulator 13 of the first example embodiment. The spatial light modulator 33 includes a modulation part 330 irradiated with the light 302. In the modulation part 330, the first modulation region 331, the second modulation region 332, the third modulation region 333, and the fourth modulation region 334 are set. A partition wall 335 divides the first modulation region 331, the second modulation region 332, the third modulation region 333, and the fourth modulation region 334 by four with a cross. The partition wall 335 divides the modulation part 330 such that the modulated lights 303-1 to 303-4 are not mixed immediately after being modulated by the modulation part 330. A pattern corresponding to the image displayed by the projection light 305 is set in each of the first modulation region 331, the second modulation region 332, the third modulation region 333, and the fourth modulation region 334 under the control of the control unit 37.

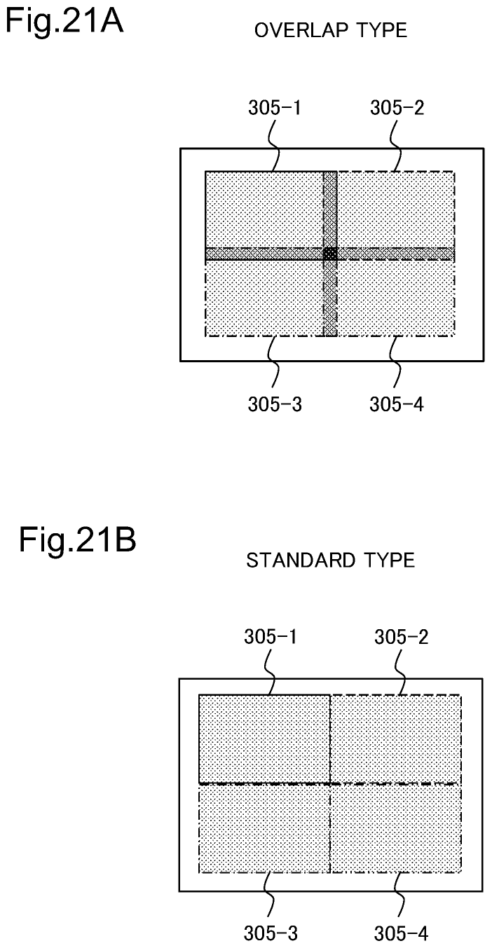

FIG. 20 illustrates an example of the first modulation region 331, the second modulation region 332, the third modulation region 333, and the fourth modulation region 334 set in the modulation part 330 of the spatial light modulator 33. Each of the first modulation region 331, the second modulation region 332, the third modulation region 333, and the fourth modulation region 334 is divided by the partition wall 335. A pattern (phase image) related to an image formed by the modulated light 303-1 is set in the first modulation region 331. A phase image related to an image formed by the modulated light 303-2 is set in the second modulation region 332. A phase image related to an image formed by the modulated light 303-3 is set in the third modulation region 333. A phase image related to an image formed by the modulated light 303-4 is set in the fourth modulation region 334. For example, in a case where only one of the modulated lights 303-1 to 303-4 is used for image display, the phase image may be set only in the modulation region from which the modulated light 303 used for image display is emitted.

The modulated lights 303-1 to 303-4 modulated in each of the first modulation region 331, the second modulation region 332, the third modulation region 333, and the fourth modulation region 334 are separated by the partition wall 335 immediately after being emitted from the modulation part 330. The modulated lights 303-1 to 303-4 can be set so as to be mixed with each other after being reflected by the reflection surface 350 of the curved mirror 35, or can be set so as not to be mixed with each other. The mixing state of the modulated lights 303-1 to 303-4 after being reflected by the reflection surface 350 of the curved mirror 35 can be set by adjusting the emission direction of the light 302 from the light source 31.

The 0th-order light remover 34 is disposed on an optical path of the modulated light 303. The 0th-order light remover 34 removes the 0th-order light included in the modulated light 303. The modulated light 303 that has passed through the 0th-order light remover 34 does not include the 0th-order light. The 0th-order light remover 34 includes a support member 340 and a light absorbing member 345. The support member 340 is similar to the support member 140 of the first example embodiment. The light absorbing member 345 is held on the optical path of the 0th-order light included in the modulated light 303 by the support member 340. In the configuration of the present example embodiment, the light absorbing member 345 is disposed on the optical path of each of the modulated lights 303-1 to 303-4. The material of the light absorbing member 345 is similar to that of the light absorbing member 145 of the first example embodiment.

The curved mirror 35 has the same configuration as the curved mirror 15 of the first example embodiment. The curved mirror 35 is a reflecting mirror having the curved reflection surface 350. The reflection surface 350 is divided into a first reflection region 351, a second reflection region 352, a third reflection region 353, and a fourth reflection region 354. The first reflection region 351 is irradiated with the modulated light 303-1. The second reflection region 352 is irradiated with the modulated light 303-2. The third reflection region 353 is irradiated with the modulated light 303-3. The fourth reflection region 354 is irradiated with the modulated light 303-4. The reflection surface 350 of the curved mirror 35 has a curved surface/curvature relevant to the projection angle of the projection light 305. The curved surfaces/curvatures of the first reflection region 351, the second reflection region 352, the third reflection region 353, and the fourth reflection region 354 may be the same or different. The curved surfaces/curvatures of the first reflection region 351, the second reflection region 352, the third reflection region 353, and the fourth reflection region 354 are set according to traveling directions of the modulated light 303 and the projection light 305. For example, the curved mirror 35 having the first reflection region 351, the curved mirror 35 having the second reflection region 352, the curved mirror 35 having the first reflection region 351, and the curved mirror 35 having the fourth reflection region 354 may be combined. The curved mirror 35 may be configured such that a reflection direction of the reflection surface 350 having the first reflection region 351, the reflection surface 350 having the second reflection region 352, the reflection surface 350 having the third reflection region 353, and the reflection surface 350 having the fourth reflection region 354 can be changed.

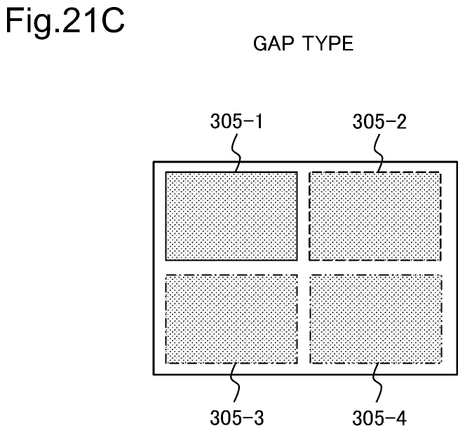

FIGS. 21A, 21B, and 21C are conceptual diagrams for explaining a projection pattern of the projection light 305 projected from the projection device 30. FIGS. 21A, 21B, and 21C are views of the projection lights 305-1 to 305-4 projected from the projection device 30 on the projection target surface as viewed from the side (front) of the projection device 30. In FIGS. 21A, 21B, and 21C, projection ranges of the projection light 305-1 (solid line), the projection light 305-2 (broken line), the projection light 305-3 (alternate long and short dash line), and the projection light 305-4 (alternate long and two short dashes line) are indicated by hatching. Several projection patterns can be achieved by adjusting emission axes of the light 302 emitted from the light source 31 in the four directions and reflection directions of the first reflection region 351, the second reflection region 352, the third reflection region 353, and the fourth reflection region 354.

FIG. 21A illustrates a pattern (overlap type) in which projection ranges of the projection lights 305-1 to 305-4 overlap each other on a projection target surface. In FIG. 21A, a state in which the projection ranges of the projection lights 305-1 to 305-4 overlap with each other is indicated by hatching. In the case of FIG. 21A, there are five patterns in which projection ranges of the projection light 305 overlap each other. The first pattern is a pattern in which the projection ranges of the projection light 305-1 and the projection light 305-2 overlap each other. The second pattern is a pattern in which the projection ranges of the projection light 305-3 and the projection light 305-4 overlap each other. The third pattern is a pattern in which the projection ranges of the projection light 305-1 and the projection light 305-3 overlap each other. The fourth pattern is a pattern in which the projection ranges of the projection light 305-2 and the projection light 305-4 overlap each other. The fifth pattern is a pattern in which the projection ranges of the projection lights 305-1 to 305-4 overlap each other. In the projection range where the projection light 305 overlaps in the first to fourth patterns, the luminance of light can be set higher than that of single projection light. In the projection range in which the projection light 305 overlaps in the fifth pattern, the luminance of light can be set higher than that in the projection range in which projection light 305 overlaps in the first to fourth patterns. In the fifth pattern, in the projection range where the projection lights 305-1 to 305-4 overlap, the luminance of the light is about 4 times as large as that of the single projection light. For example, in an application in which light with high luminance is required, such as a case of inspecting a scratch or the like on the surface of an object, the projection light 305 may be projected in the overlapping pattern of FIG. 21A.

FIG. 21B illustrates a pattern (standard type) in which the projection ranges of the projection lights 305-1 to 305-4 are adjacent to each other without overlapping each other on the projection target surface. The projection light 305 may be projected in the standard pattern of FIG. 21B in an application in which an image is displayed on the projection target surface or an application in which light having uniform luminance is required.

FIG. 21C illustrates a pattern (gap type) in which there is a gap between the projection ranges of the projection lights 305-1 to 305-4. In an application in which the projection light 305 is projected from single the single projection device 30 to different projection targets, the projection light 305 may be projected in a gap pattern in FIG. 21C.

As described above, the projection device of the present example embodiment includes the light source, the spatial light modulator, the partition wall, the 0th-order light remover, the control unit, and the curved mirror. The spatial light modulator includes a modulation part in which four modulation regions irradiated with light emitted from a light source are set. The spatial light modulator modulates the phase of the emitted light in each of the four modulation regions set in the modulation part. The partition wall is disposed at a boundary between the four modulation regions. The partition wall separates the modulated light modulated by each of the four modulation regions. The 0th-order light remover includes four light absorbing members associated with four modulation regions set in the modulation part of the spatial light modulator, and a support member that supports the four light absorbing members. Each of the four light absorbing members is disposed in an optical path of the 0th-order light included in modulated light modulated in the associated modulation region. Each of the four light absorbing members removes the 0th-order light included in the modulated light modulated in the associated modulation region. The control unit sets a pattern for forming a desired image in each of the four modulation regions set in the modulation part of the spatial light modulator. The control unit controls the light source so that the modulation part in which the pattern is set is irradiated with light. The curved mirror has a curved reflection surface irradiated with the modulated light modulated for every four modulation regions set in the modulation part of the spatial light modulator. The curved mirror reflects the modulated light on the reflection surface, and projects projection light having an enlarged projection angle according to the curvature of the reflection surface.

Since the projection device of the present example embodiment does not include a projection optical system such as a Fourier transform lens or a projection lens, it can be configured compactly. The projection device of the present example embodiment sets a pattern for each projection range in four modulation regions set in the modulation part of the spatial light modulator. Therefore, according to the projection device of the present example embodiment, the projection light can be projected toward a wide range including four projection ranges. In the projection device of the present example embodiment, since the partition wall is disposed at the boundary between the four modulation regions, the modulated light modulated in the different modulation regions is not mixed immediately after emission. Therefore, according to the projection device of the present example embodiment, it is possible to prevent higher-order light associated with a desired image from being projected on an adjacent projection range. Furthermore, since the projection device of the present example embodiment removes the 0th-order light included in the modulated light, the 0th-order light is not projected in the projection range. That is, according to the projection device of the present example embodiment, projection light not including an unnecessary light component can be projected over a wide range while having a compact configuration.

In one aspect of the present example embodiment, the partition wall is disposed to stand substantially perpendicular to the modulation part of the spatial light modulator at all boundaries of the four modulation regions. According to the present aspect, since the partition walls are erected at all the boundaries of the four modulation regions, the higher-order light of the desired image is hardly displayed on the projection target surface.

In one aspect of the present example embodiment, the control unit sets a composite image obtained by combining a phase image for forming a desired image and a virtual lens image for condensing modulated light for forming a desired image on the reflection surface of the curved mirror, in each of the four modulation regions set in the modulation part of the spatial light modulator. According to the present aspect, since the condensing position of the virtual lens image is installed on the reflection surface of the curved mirror, the desired image can be displayed more clearly on the projection target surface.

In one aspect of the present example embodiment, the light source includes an emitter, a lens, and an optical system. The emitter emits light. The lens enlarges the light emitted from the emitter in accordance with the size of the modulation part of the spatial light modulator. The optical system divides and emits the light enlarged by the lens toward each of the four modulation regions. According to the present aspect, it is possible to achieve a light source that emits light toward four modulation regions using a single emitter.

In one aspect of the present example embodiment, the light source includes four emitters and four lenses. Each of the four emitters is associated with one of the four modulation regions. Each of the four emitters is disposed with the emission axis facing the associated modulation region. Each of the four emitters emits light. Each of the four lenses is disposed in association with each of the four emitters. Each of the four lenses enlarges the light emitted from the associated emitter in accordance with the size of the modulation part of the spatial light modulator. The projection device of this aspect does not include an optical system that divides light. Therefore, according to the present aspect, since light loss does not occur in the optical system, the efficiency of light emitted from the light source can be improved.

In one aspect of the present example embodiment, the curved mirror is associated with four modulation regions, and the reflection surface is divided into four reflection regions. The curved mirror is disposed at a position where the modulated light modulated in each of the four modulation regions is reflected by the reflection region associated with the modulated light. According to the present aspect, by dividing the reflection surface of the curved mirror into the four reflection regions, the projection light based on the modulated light modulated in each of the four modulation regions can be more accurately projected toward the desired projection range.

In one aspect of the present example embodiment, in the curved mirror, four reflection regions are set such that projection ranges of projection light reflected by the four reflection regions overlap each other on the projection target surface. In this aspect, a region where projection light projected toward four projection ranges overlaps each other is formed. Therefore, according to the present aspect, it is possible to project high luminance light in a region where projection light projected toward four projection ranges overlaps each other.

In one aspect of the present example embodiment, in the curved mirror, four reflection regions are set such that projection ranges of projection light reflected by the four reflection regions do not overlap each other on the projection target surface. In the present example embodiment, a region where projection light projected toward four projection ranges overlaps each other is not formed. When a region where projection light projected toward four projection ranges overlaps with each other is unexpectedly formed, there is a possibility that high luminance light is projected on a region where the luminance is desired to be set low. According to the present aspect, since the region where the projection light projected toward the four projection ranges overlaps with each other is not formed, it is possible to prevent occurrence of an unexpected high luminance region.

In one aspect of the present example embodiment, in the curved mirror, four reflection regions are set such that projection ranges of projection light reflected by the four reflection regions are adjacent to each other on the projection target surface. In the present aspect, the projection light reflected by the four reflection regions is projected on projection ranges adjacent to each other. Therefore, according to the present aspect, a seamless image and continuous display information can be formed in adjacent projection ranges.

### Fourth Example Embodiment

Next, a projection device according to a fourth example embodiment will be described with reference to the drawings. The projection device of the present example embodiment has a configuration in which the projection devices of the first to third example embodiments are simplified.

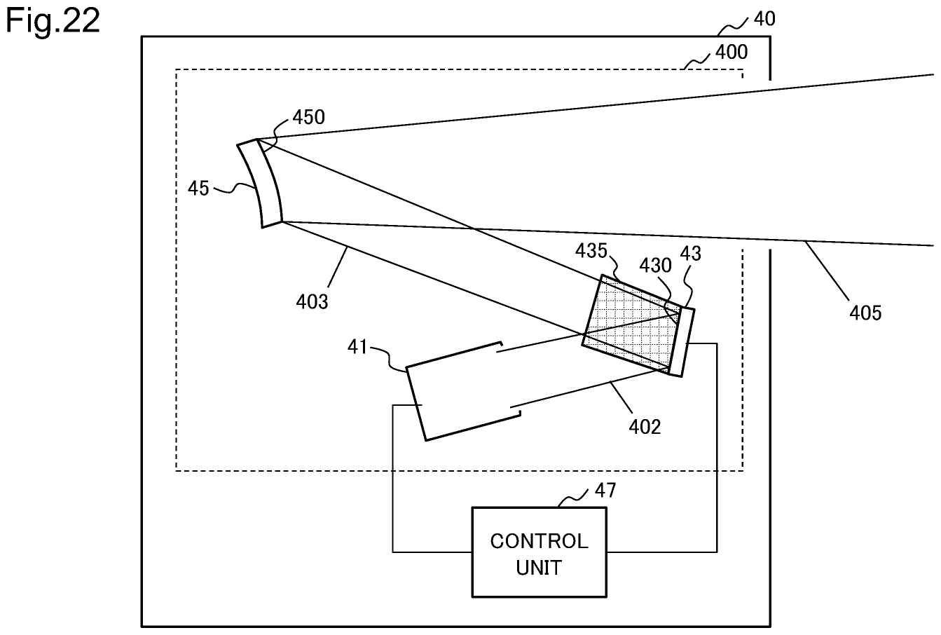

FIG. 22 is a block diagram illustrating an example of a configuration of a projection device 40 according to the present example embodiment. The projection device 40 includes a light source 41, a spatial light modulator 43, a curved mirror 45, and a control unit 47. FIG. 22 is a diagram illustrating an internal configuration of the projection device 40 as viewed from the lateral direction.

The light source 41 emits light 402. The spatial light modulator 43 includes a modulation part 430. A plurality of modulation regions irradiated with the light 402 emitted from the light source 41 are set in the modulation part 430. The spatial light modulator 43 modulates the phase of the emitted light 402 with each of the plurality of modulation regions set in the modulation part 430. A partition wall 435 is disposed at a boundary between the plurality of modulation regions. The partition wall 435 separates the modulated light 403 modulated by each of the plurality of modulation regions. The control unit 47 sets a pattern for forming a desired image in each of the plurality of modulation regions set in the modulation part 430 of the spatial light modulator 43. The control unit 47 controls the light source 41 so that the modulation part 430 in which the pattern is set is irradiated with the light 402. The curved mirror 45 has a curved reflection surface 450 irradiated with the modulated light 403 modulated for each of the plurality of modulation regions set in the modulation part 430 of the spatial light modulator 43. The curved mirror 45 reflects the modulated light 403 by the reflection surface 450, and projects the projection light 405 whose projection angle is enlarged according to the curvature of the reflection surface 450.

As described above, since the projection device of the present example embodiment does not include a projection optical system such as a Fourier transform lens or a projection lens, it can be configured compactly. The projection device of the present example embodiment sets a pattern for each projection range in the plurality of modulation regions set in the modulation part of the spatial light modulator. Therefore, according to the projection device of the present example embodiment, the projection light can be projected toward a wide range including the plurality of projection ranges. In the projection device of the present example embodiment, since the partition wall is disposed at the boundary between the plurality of modulation regions, the modulated light modulated in the different modulation regions is not mixed immediately after emission. Therefore, according to the projection device of the present example embodiment, it is possible to prevent higher-order light associated with a desired image from being projected on an adjacent projection range. That is, according to the projection device of the present example embodiment, the projection light not including higher-order light of a desired image can be projected over a wide range while having a compact configuration.

In the first to third example embodiments, an example has been described in which the modulation part of the spatial light modulator is divided into 2 to 4 modulation regions. The modulation part of the spatial light modulator is not limited to the examples of the first to third example embodiments, and may be divided into five or more modulation regions.

### (Hardware)

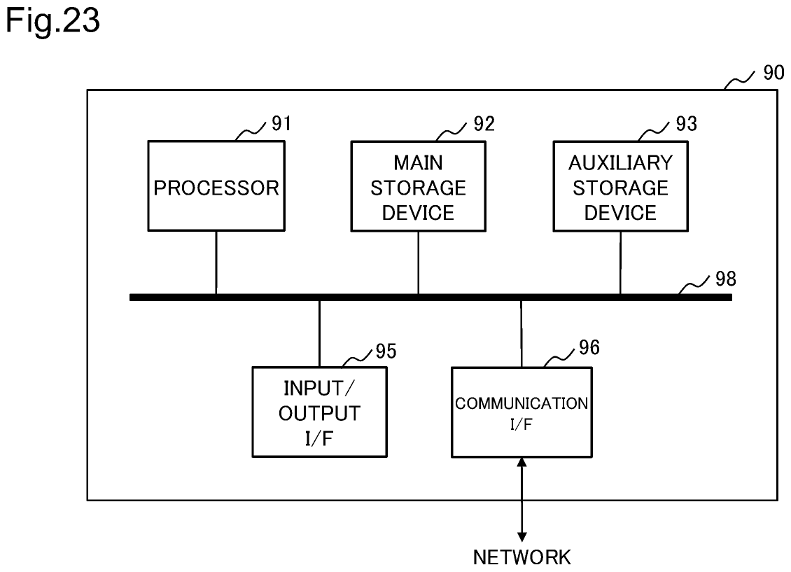

Here, a hardware configuration for executing processing of the control unit according to each example embodiment of the present disclosure will be described using an information processing device 90 of FIG. 23 as an example. The information processing device 90 in FIG. 23 is a configuration example for executing the control and processing of each example embodiment, and does not limit the scope of the present disclosure.

As illustrated in FIG. 23, the information processing device 90 includes a processor 91, a main storage device 92, an auxiliary storage device 93, an input/output interface 95, and a communication interface 96. In FIG. 23, the interface is abbreviated as an I/F. The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via communication interface 96.

The processor 91 develops a program stored in the auxiliary storage device 93 or the like in the main storage device 92. The processor 91 executes the program developed in the main storage device 92. In the present example embodiment, a software program installed in the information processing device 90 may be used. The processor 91 executes processing or control according to the present example embodiment.

The main storage device 92 has a region in which a program is developed. A program stored in the auxiliary storage device 93 or the like is developed in the main storage device 92 by the processor 91. The main storage device 92 is implemented by, for example, a volatile memory such as a dynamic random access memory (DRAM). A nonvolatile memory such as a magnetoresistive random access memory (MRAM) may be configured and added as the main storage device 92.

The auxiliary storage device 93 stores various data such as programs. The auxiliary storage device 93 is implemented by a local disk such as a hard disk or a flash memory. Various data may be stored in the main storage device 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When the touch panel is used as an input device, the display screen of the display device may also serve as the interface of the input device. Data communication between the processor 91 and the input device may be mediated by the input/output interface 95.

The information processing device 90 may be provided with a display device for displaying information. In a case where a display device is provided, the information processing device 90 may include a display control device (not illustrated) for controlling display of the display device. The display device may be connected to the information processing device 90 via input/output interface 95.

The information processing device 90 may be provided with a drive device. The drive device mediates reading of data and a program from a recording medium, writing of a processing result of the information processing device 90 to the recording medium, and the like between the processor 91 and the recording medium (program recording medium). The drive device may be connected to the information processing device 90 via input/output interface 95.

The above is an example of the hardware configuration for enabling the control and processing according to each example embodiment of the present invention. The hardware configuration of FIG. 23 is an example of a hardware configuration for executing the control and processing of each example embodiment, and does not limit the scope of the present invention. A program for causing a computer to execute the control and processing according to each example embodiment is also included in the scope of the present invention. Further, a program recording medium in which the program according to each example embodiment is recorded is also included in the scope of the present invention. The recording medium can be achieved by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium. When a program executed by the processor is recorded in a recording medium, the recording medium is associated to a program recording medium.

The components of each example embodiment may be arbitrarily combined. The components of each example embodiment may be implemented by software or may be implemented by a circuit.

Although the present invention has been described with reference to the example embodiments, the present invention is not limited to the above example embodiments. Various modifications that can be understood by those skilled in the art can be made to the configuration and details of the present invention within the scope of the present invention.

Some or all of the above example embodiments may be described as the following Supplementary Notes, but are not limited to the following.

### (Supplementary Note 1)

A projection device including:
a light source;
a spatial light modulator that has a modulation part in which a plurality of modulation regions to be irradiated with light emitted from the light source are set, and modulates a phase of the irradiated light in each of the plurality of modulation regions set in the modulation part;
a partition wall that is disposed at a boundary between the plurality of modulation regions and separates modulated light modulated in each of the plurality of modulation regions;
a control means configured to set a pattern for forming a desired image in each of the plurality of modulation regions set in the modulation part of the spatial light modulator, and control the light source such that the modulation part in which the pattern is set is irradiated with the light; and
a curved mirror that has a curved reflection surface to be irradiated with the modulated light modulated in each of the plurality of modulation regions set in the modulation part of the spatial light modulator, reflects the modulated light by the reflection surface, and projects projection light of which a projection angle is widened according to a curvature of the reflection surface.

### (Supplementary Note 2)

The projection device according to Supplementary Note 1, in which
the partition wall is
arranged to stand substantially perpendicular to the modulation part of the spatial light modulator at all boundaries of the plurality of modulation regions.

### (Supplementary Note 3)

The projection device according to Supplementary Note 1 or 2, in which
the control means
sets a composite image obtained by combining a phase image for forming a desired image and a virtual lens image for condensing the modulated light for forming the desired image on the reflection surface of the curved mirror in each of the plurality of modulation regions set in the modulation part of the spatial light modulator.

### (Supplementary Note 4)

The projection device according to any one of Supplementary Notes 1 to 3, including:
a 0th-order light remover including a plurality of light absorbing members associated with each of the plurality of modulation regions set in the modulation part of the spatial light modulator, and a support member supporting the plurality of light absorbing members, in which
each of the plurality of light absorbing members is arranged in an optical path of 0th-order light included in the modulated light modulated in the associated modulation region, and removes the 0th-order light included in the modulated light modulated in the associated modulation region.

### (Supplementary Note 5)

The projection device according to any one of Supplementary Notes 1 to 4, in which
the light source includes:
an emitter that emits the light;
a lens that enlarges the light emitted from the emitter in accordance with a size of the modulation part of the spatial light modulator; and
an optical system that divides and emits the light enlarged by the lens toward each of the plurality of modulation regions.

### (Supplementary Note 6)

The projection device according to any one of Supplementary Notes 1 to 4, in which
the light source includes:
a plurality of emitters configured to emit the light; and
at least one lens that is disposed in association with each of the plurality of emitters and enlarges the light emitted from the associated emitter in accordance with a size of the modulation part of the spatial light modulator, and
each of the plurality of emitters is
associated with one of the plurality of modulation regions, and is arranged with an emission axis facing the associated modulation region.

### (Supplementary Note 7)

The projection device according to any one of Supplementary Notes 1 to 6, in which
the curved mirror includes:
the reflection surface that is divided into a plurality of reflection regions in association with the plurality of modulation regions, and
the curved mirror is
disposed at a position where the modulated light modulated in each of the plurality of modulation regions is reflected by the reflection region associated with the modulated light.

### (Supplementary Note 8)

The projection device according to Supplementary Note 7, in which
the curved mirror includes:
the plurality of reflection regions that are set such that projection ranges of the projection light reflected by the plurality of reflection regions overlap each other on a projection target surface.

### (Supplementary Note 9)

The projection device according to Supplementary Note 7, in which
the curved mirror includes:
the plurality of reflection regions that are set such that projection ranges of the projection light reflected by the plurality of reflection regions does not overlap each other on a projection target surface.

### (Supplementary Note 10)

The projection device according to Supplementary Note 9, in which
the curved mirror includes:
the plurality of reflection regions that are set such that projection ranges of the projection light reflected by the plurality of reflection regions are adjacent to each other on a projection target surface.

### (Supplementary Note 11)

A projection control method for controlling a projection device including a light source, a spatial light modulator that has a modulation part in which a plurality of modulation regions to be irradiated with light emitted from the light source are set, and modulates a phase of the irradiated light in each of the plurality of modulation regions set in the modulation part, a partition wall that is disposed at a boundary between the plurality of modulation regions and separates modulated light modulated in each of the plurality of modulation regions, and a curved mirror that has a curved reflection surface to be irradiated with the modulated light modulated in each of the plurality of modulation regions set in the modulation part of the spatial light modulator, reflects the modulated light by the reflection surface, and projects projection light of which a projection angle is widened according to a curvature of the reflection surface, the projection control method including:
setting a plurality of the modulation regions in the modulation part of the spatial light modulator;
setting a pattern for forming a desired image in each of the plurality of modulation regions set in the modulation part of the spatial light modulator; and
controlling the light source so that the light is emitted to the modulation part in which the pattern is set.

### (Supplementary Note 12)

A program for controlling a projection device including a light source, a spatial light modulator that has a modulation part in which a plurality of modulation regions to be irradiated with light emitted from the light source are set, and modulates a phase of the irradiated light in each of the plurality of modulation regions set in the modulation part, a partition wall that is disposed at a boundary between the plurality of modulation regions and separates modulated light modulated in each of the plurality of modulation regions, and a curved mirror that has a curved reflection surface to be irradiated with the modulated light modulated in each of the plurality of modulation regions set in the modulation part of the spatial light modulator, reflects the modulated light by the reflection surface, and projects projection light of which a projection angle is widened according to a curvature of the reflection surface, the program causing a computer to execute:
setting a plurality of the modulation regions in the modulation part of the spatial light modulator;
setting a pattern for forming a desired image in each of the plurality of modulation regions set in the modulation part of the spatial light modulator; and
controlling the light source so that the light is emitted to the modulation part in which the pattern is set.

This application is based upon and claims the benefit of priority from Japanese patent application No. 2021-138619, filed on Aug. 27, 2022, the disclosure of which is incorporated herein in its entirety by reference.

### REFERENCE SIGNS LIST

10, 20, 30, 40 projection device
11, 21, 31, 41 light source
13, 23, 33, 43 spatial light modulator
14, 24, 34, 44 0th-order light remover
15, 25, 35, 45 curved mirror
17, 27, 37, 47 control unit
111, 211, 311 emitter
112, 212, 312 lens
113 beam splitter
114 branch mirror
115 emission mirror
135, 235, 335, 435 partition wall
140, 240, 340 support member
145, 245, 345 light absorbing member

What is claimed is:

1. A projection device comprising:
a light source;
a spatial light modulator that has a modulation part in which a plurality of modulation regions to be irradiated with light emitted from the light source are set, and modulates a phase of the irradiated light in each of the plurality of modulation regions set in the modulation part;
a partition wall that is disposed at a boundary between the plurality of modulation regions and separates modulated light modulated in each of the plurality of modulation regions;
a controller comprising
a memory storing instructions, and
a processor connected to the memory and configured to execute the instructions to
set a pattern for forming a desired image in each of the plurality of modulation regions set in the modulation part of the spatial light modulator, and
control the light source such that the modulation part in which the pattern is set is irradiated with the light; and
a curved mirror that has a curved reflection surface to be irradiated with the modulated light modulated in each of the plurality of modulation regions set in the modulation part of the spatial light modulator, reflects the modulated light by the reflection surface, and projects projection light of which a projection angle is widened according to a curvature of the reflection surface.

2. The projection device according to claim 1, wherein
the partition wall is arranged to stand substantially perpendicular to the modulation part of the spatial light modulator at all boundaries of the plurality of modulation regions.

3. The projection device according to claim 1, wherein
the processor of the controller is configured to execute the instructions to
set a composite image obtained by combining a phase image for forming a desired image and a virtual lens image for condensing the modulated light for forming the desired image on the reflection surface of the curved mirror in each of the plurality of modulation regions set in the modulation part of the spatial light modulator.

4. The projection device according to claim 1, comprising:
a 0th-order light remover including a plurality of light absorbing members associated with each of the plurality of modulation regions set in the modulation part of the spatial light modulator, and a support member supporting the plurality of light absorbing members, wherein
each of the plurality of light absorbing members is arranged in an optical path of 0th-order light included in the modulated light modulated in the associated modulation region, and removes the 0th-order light included in the modulated light modulated in the associated modulation region.

5. The projection device according to claim 1, wherein
the light source includes:
an emitter that emits the light;
a lens that enlarges the light emitted from the emitter in accordance with a size of the modulation part of the spatial light modulator; and
an optical system that divides and emits the light enlarged by the lens toward each of the plurality of modulation regions.

6. The projection device according to claim 1, wherein
the light source includes:
a plurality of emitters configured to emit the light; and
at least one lens that is disposed in association with each of the plurality of emitters and enlarges the light emitted from the associated emitter in accordance with a size of the modulation part of the spatial light modulator, and wherein
each of the plurality of emitters is associated with one of the plurality of modulation regions, and is arranged with an emission axis facing the associated modulation region.

7. The projection device according to claim 1, wherein
the reflection surface of the curved mirror is divided into a plurality of reflection regions in association with the plurality of modulation regions, and
the curved mirror is disposed at a position where the modulated light modulated in each of the plurality of modulation regions is reflected by the reflection region associated with the modulated light.

8. The projection device according to claim 7, wherein
the plurality of reflection regions of the curved mirror are set such that projection ranges of the projection light reflected by the plurality of reflection regions overlap each other on a projection target surface.

9. The projection device according to claim 7, wherein
the plurality of reflection regions of the curved mirror are set such that projection ranges of the projection light reflected by the plurality of reflection regions does not overlap each other on a projection target surface.

10. The projection device according to claim 9, wherein
the plurality of reflection regions the curved mirror are set such that projection ranges of the projection light reflected by the plurality of reflection regions are adjacent to each other on a projection target surface.

11. A projection control method for controlling a projection device including a light source, a spatial light modulator that has a modulation part in which a plurality of modulation regions to be irradiated with light emitted from the light source are set, and modulates a phase of the irradiated light in each of the plurality of modulation regions set in the modulation part, a partition wall that is disposed at a boundary between the plurality of modulation regions and separates modulated light modulated in each of the plurality of modulation regions, and a curved mirror that has a curved reflection surface to be irradiated with the modulated light modulated in each of the plurality of modulation regions set in the modulation part of the spatial light modulator, reflects the modulated light by the reflection surface, and projects projection light of which a projection angle is widened according to a curvature of the reflection surface, the projection control method comprising:
setting a plurality of the modulation regions in the modulation part of the spatial light modulator;
setting a pattern for forming a desired image in each of the plurality of modulation regions set in the modulation part of the spatial light modulator; and
controlling the light source in such a way that the light is emitted to the modulation part in which the pattern is set.

12. A non-transitory recording medium having stored therein a program for controlling a projection device including a light source, a spatial light modulator that has a modulation part in which a plurality of modulation regions to be irradiated with light emitted from the light source are set, and modulates a phase of the irradiated light in each of the plurality of modulation regions set in the modulation part, a partition wall that is disposed at a boundary between the plurality of modulation regions and separates modulated light modulated in each of the plurality of modulation regions, and a curved mirror that has a curved reflection surface to be irradiated with the modulated light modulated in each of the plurality of modulation regions set in the modulation part of the spatial light modulator, reflects the modulated light by the reflection surface, and projects projection light of which a projection angle is widened according to a curvature of the reflection surface, the program causing a computer to execute:
setting a plurality of the modulation regions in the modulation part of the spatial light modulator;
setting a pattern for forming a desired image in each of the plurality of modulation regions set in the modulation part of the spatial light modulator; and
controlling the light source in such a way that the light is emitted to the modulation part in which the pattern is set.
